(19) United States
(12) Patent Application Publication
(10) Pub. No.: US 2016/0241676 A1
(43) Pub. Date: Aug. 18, 2016

(54) METHOD AND APPARATUS FOR STORING, ACCESSING AND DISPLAYING PAST APPLICATION STATES

(71) Applicant: Dashcube LLC, McLean, VA (US)

(72) Inventors: Peter Burton Armstrong, Victoria (CA); Kenneth Nichlas Pratt, Vancouver (CA); Cory Matthew Binnersley, Victoria (CA); Braden Levi Simpson, Victoria (CA); Steven Luscher, Vancouver (CA)

(73) Assignee: Dashcube LLC, McLean, VA (US)

(21) Appl. No.: 15/045,814

(22) Filed: Feb. 17, 2016

Related U.S. Application Data
(60) Provisional application No. 62/117,605, filed on Feb. 18, 2015.

(51) Int. Cl. H04L 29/08; H04L 29/06; G06F 17/30; H04L 12/24

(52) U.S. Cl. CPC H04L 67/36; H04L 41/22; H04L 67/42; G06F 17/30368; G06F 17/30398; H04L 67/1095; G06F 17/30516

(57) ABSTRACT

A system for allowing access to past data states of a software application, and allowing playback of the data state forward through time. This system captures changes to application data over time, and allows a client application to perform queries for a past time as well as the present time, in order to retrieve a data set representing the state of the application data at the desired point in time. Additionally, the system allows a client application to stream past changes over time, as well as stream live changes at the current point in time.

### RELATED APPLICATIONS

The present application claims the benefit of U.S. Provisional Patent Application No. 62/117,605 filed Feb. 18, 2015 by the same inventors and entitled “Storing, Accessing and Displaying Past Application States,” which provisional application is hereby incorporated by reference as if repeated herein in its entirety, including the drawings.

### BACKGROUND

The present invention relates generally to methods and apparatuses for enabling multiple participants to engage in enterprise communications, and more particularly to a computer implemented method and apparatus for enabling one or more participants to engage in an enterprise communications in a controlled manner.

“Enterprise Communications” encompasses sending and receiving of text, voice and video communications between two or more parties, as well as the sharing of enterprise data through electronic charts, graphs, timelines, calendars, task summaries, project plans and other such business data visualization methods.

In enterprises with multiple parties communicating with each other at high frequencies and in varied communications modes (such as text, voice, video and/or visual data), often questions arise regarding who knew what about past enterprise activities, current enterprise status and/or future enterprise plans. One can readily imagine the need to answer such questions for regulatory compliance reasons as well as to support a project post mortem, an audit or an investigation.

Under existing enterprise software communications platforms sorting out this communication information in a coherent and comprehensive manner is not always possible even if all the data is recorded. Typically, one would have to sort through large amounts of data—a task which is so daunting most do not even start such a task unless the reward for doing so is extremely high to justify the effort.

Independent of any possible audit or investigation, managers and executives wish to discover the “unknown unknowns” in a business, i.e., the information about which they should be asking questions, but do not even know what questions to ask. However, to do so requires a thorough understanding of the past.

The present invention therefore is directed to the problem of providing an enterprise software communications platform for managing efforts that enables one to capture the state of the varied communications efforts on the platform at any point in time and permit analysis of the recorded information to enable one to better understand the development of the effort.

### SUMMARY OF THE INVENTION

The present invention solves these and other problems by providing an enterprise software communications platform that enables users to communicate with each other via voice, video and text as well as to share and track metrics dashboards and project tasks, in which all communication functions and related data reside within separate virtual containers.

Enterprises can employ these virtual containers based on various types of business logic, organizational conventions and ad hoc needs. More specifically, enterprises will likely create virtual containers based on organizational departments (e.g., sales, marketing, human resources, etc.), customers, suppliers, products, office locations and enterprise initiatives, although the system places no requirements or constraints on how an enterprise chooses the segmentation of its communications effort.

In combination with this enterprise software communications platform, the present invention provides a replay feature, i.e., the ability to go back in time and view past states of these virtual containers as well as to “play back” the history of a virtual container. Moreover, the present invention provides the ability to dynamically revisit any point in time in the history of a virtual container since the virtual container was created, and inspect any of the information contained within the virtual container, simply by dragging a time slider to the time in the history of the virtual container's lifetime that one desires to inspect. From that point, a user may play changes forward at a selection of playback rates, pause playback, and skip around in time. By playing back the history of the virtual container certain aspects of the information contained therein become more evident due to the dynamic nature of such a display. Thus, important analytics and relationships become evident that might otherwise remain clouded in the sheer amount of data and information being presented in a static view.

As one example, managers may develop and share a monthly inventory aging dashboard, showing three columns with the dollar value of inventory: (i) less than 31 days old; (ii) 31 to 90 days old; and (iii) more than 90 days old. In many businesses, it would be common for such a monthly chart to get tracked for years. If managers observed a notable improvement or a drastic decline in the inventory aging performance, the managers can benefit from a method of “replaying” the inventory aging performance chart from a month in the past to a later month, perhaps all the way forward to the most recent month for which inventory aging data got posted. Such replay transforms a normally static chart into a dynamic video-like experience, potentially, revealing whether something occurred at particular point in the past that produced a material impact on current inventory. Managers could then identify the event and update enterprise policies and practices to reflect the learning and improve performance. The present invention enables just this type of dynamic analysis.

An exemplary embodiment of the present invention of an enterprise software communications platform with a replay feature employs an innovative client-server protocol, a unique client architecture, a custom event processing and storage system, and a novel temporal database server to allow efficient storage, retrieval and streaming of replay data. Certain aspects of the present invention could be employed in other software environments without departing from the scope of the present invention.

It should be noted that the innovations described herein relate directly to improvements to the functioning of a computer or computer software itself. For example, disclosed herein are novel aspects of organizing data to permit rapid replaying of the historical states of the data, a unique client-server protocol, a unique client-server architecture, a custom event processing and storage system, and a novel temporal database server, which in various combinations allow efficient storage, retrieval and streaming of replay data for software systems or any large data organizing system.

Other aspects of the present invention include methods for capturing, storing, retrieving, and playing back historical application states, and how all of these components interact, as well as the innovative client/server protocol.

According to another aspect of the present invention, an apparatus for storing and replaying one or more past states of a virtual container (e.g., a metrics dashboard, a project, workspace, text communication stream, Kanban board, organizational group, etc.) includes an application server, an event storage database, a temporal database server and a non-transitory computer readable media having stored thereon instructions for a processor to execute a client application.

In this apparatus, the application server couples to clients and executes an application to enable users of the clients to communicate amongst each other and to collaborate with each other, such as developing a project or working together towards a common goal.

In this apparatus, the event storage database stores: i) user commands, which capture user action and data associated with the user action; and ii) change sets, which include a result of processing the user action in a format that can be stored without processing any further logic or needed access to a specific version of application logic that handled the user action at a point in time at which the user action occurred.

In this apparatus, the temporal database server is coupled to the event storage database and stores an in-memory representation of a current state of the project as viewed in the application and past states of the project as viewed in the application and each change set to transition from each past state to a next state in time up through the current state.

In this apparatus, the client application provides a user interface for clients to interact with the application server. The client application includes several components, such as a user interface component, a query engine, a reality state and a server agent. Other components may be included in the client application (such as those that relate to the enterprise software communications platform core functions) but these components are those necessary for the replay feature as described above. It should be noted that the functions set forth below that are performed in the specific components in the client application could be moved among other components of the client application without departing from the scope of the present invention.

In this apparatus, the user interface component declares a list of queries representing data dependencies of the user interface on data managed by the application server. There may be one or more user interface components for each client, depending on the needs of the client.

In this apparatus, the query engine captures data requirements of the user interface component and updates the user interface component as data changes that affect the user interface component. To do so, the query engine declares subscriptions in response to user interface changes depending on data needed to render the user interface component being displayed on a screen. The subscriptions cause the application server to automatically send updates to the client application when new data matching any of the subscriptions becomes available, or when data is changed or removed that matches any of the subscriptions.

In this apparatus, the reality state maintains an in-memory representation of a temporal state of the user interface based on state messages sent to the client from the application server, wherein the state messages include a reality identifier, and a list of changes, which include the operation type, a record identifier and data related to the operation. State messages are sent in response to the subscriptions.

In this apparatus, the server agent communicates with the application server, wherein the reality state communicates with the application server via the server agent. For every subscription executed, the reality state sends a single subscription message to the application server, receives zero or more state messages in response to the single subscription message, receives a single result message from the server, and may receive one or more sporadic additional state messages, as further updates to data related to the subscription occur.

In this apparatus the application server supports multiple temporal contexts to enable different user interface components of the clients to display different states of the virtual container as viewed by the application at different historical times. Control signals from the client applications, along with all data requirements, are synchronized to the application server, which then controls streaming of data to the clients.

In this apparatus, the application server may include several components, such as a client agent, a subscription bundle, a reality state and a command handler for each client. Other components may be included in the application server (for example, such as those that relate to the enterprise software communications platform core functions) but these components are those necessary for the replay feature as described above. It should be noted that the functions set forth below that are performed in the specific components in the application server could be moved among other components of the application server without departing from the scope of the present invention.

In this apparatus, the client agent communicates with each of the clients, represents an open client connection and acts as a broker on behalf of the connected clients. The client agent maintains a list of open realities, accepts incoming command requests, subscription requests and replay control requests.

In this apparatus, the subscription bundle processes subscription requests and processes change sets from the temporal database server either from change sets newly-generated in response to user commands or from change sets generated while streaming back changes in a replay state.

In this apparatus, the reality state: (i) processes subscription requests; (ii) applies permissions and security logic before handing off subscription requests to the subscription bundle; (iii) accepts change sets from the subscription bundle; and (iv) applies permissions and security logic before returning change sets to the client agent to send in a message to a client.

In this apparatus, the command handler is coupled to the event storage database, processes incoming commands, translates the commands into change sets and sends the change sets to the event storage database for storage therein. In turn, the event storage database forwards the change sets to the temporal database server.

In this apparatus, the reality state may be either a live reality state representing a current state of the virtual container as currently existing in the application, or a replay reality state representing a state of the virtual container as existing in the application at a past time. For a live reality state, the reality state: (i) passes subscription requests through to the subscription bundle; and (ii) watches for change sets being generated as incoming commands are processed and feeds those generated change sets to the subscription bundle. In the case of a replay reality state, the reality state passes subscription requests through to the subscription bundle while extending the subscription requests with a current time of a replay state.

In this apparatus, it should be noted that the replay reality state may be playing or paused. If the replay reality state is playing, the reality state fetches a list of change sets from the temporal database server every incremental time step by: a) checking a desired number of change sets given by a current playback speed in a reality metadata; b) creating a list of outgoing change sets; c) if there are no change sets in a change set queue, requesting a batch of change sets from the temporal database server, starting from a last recorded time and advancing a last recorded batch time; d) if there is at least one change set in the change set queue: (i) removing a first change set from the change set queue; (ii) sending the change set to the subscription bundle for processing; (iii) accepting a returned change set, if any; and (iv) if a change set was returned from the subscription bundle, adding the returned change set to any outgoing change sets; e) if there are enough change sets in the outgoing change sets, sending these change sets to the subscription bundle; and f) if there are not enough change sets in the outgoing change sets, repeating steps c) through e).

In this apparatus, if the replay reality state is paused, the reality state waits for further subscription requests or replay control requests.

In this apparatus, the reality state processes incoming replay control signals by manipulating a state of the replay. This manipulation depends on the type of replay control signals.

In this apparatus, the incoming replay control signals include: a create reality signal, which creates a reality with a replay in a paused state synchronized to a creation time of the project; a dispose reality signal, which terminates a replay; a play signal, which transitions a replay from the paused state to a playing state; a pause signal, which transitions a replay from the playing state to the paused state; a set replay speed signal, which updates a playback speed in the replay metadata, which is used while playing to determine a number of change sets to return; and a seek signal, which given a desired percentage of completion of the replay, sends necessary changes to skip to a desired replay completion. Other control signals may be used without departing from the scope of the present invention.

In this apparatus, upon receipt of a seek signal the reality state: retrieves a desired completion percentage from a metadata in the seek signal; converts the desired completion percentage into a converted time; retrieves a list of change sets from the temporal database server from a current replay time to the converted time; sends each change set to the subscription bundle and collects all results; updates a current time in the replay metadata; and sends all resulting change sets to the client agent.

In this apparatus, the subscription bundle processes the subscription requests by: a) storing metadata about the subscription requests; b) sending a query to the temporal database server containing a criteria from the subscription requests, which returns zero or more records; c) filtering out any returned records that the client has already received; and d) sending any remaining records as a change set of add changes to the client agent for delivery to the client in a state message, and storing metadata that the subscription bundle has done so.

In this apparatus, the subscription bundle processes the change sets by first breaking the change sets into individual changes, which could include an add operation, an update operation, or a remove operation. Then for each individual change, the subscription bundle detects whether the individual change is relevant to any active subscriptions. In some cases, the subscription bundle may substitute an add operation or a remove operation in place of an update operation. Once the subscription bundle has generated all of the individual changes in the change sets, the subscription bundle sending the individual changes to the client agent for delivery to the client in a state message, and stores metadata that the subscription bundle has done so.

According to another aspect of the present invention, an exemplary embodiment of an apparatus for storing and replaying past states of virtual containers (e.g., projects, workspaces, workplaces, units, organizational sections, etc.) being managed by an enterprise software communications platform enables users for each virtual container to communicate with each other via voice, video and text as well as to share and track metrics, dashboards and tasks. This apparatus includes an application server to execute the enterprise software communications platform, which application server is coupled to clients and is exposed to a network and listens for new connections from new clients. This apparatus includes an event storage database to store: i) user commands, which capture user action and data associated with the user action; and ii) change sets, which include a result of processing the user action in a format that can be stored without processing any further logic or needed access to a specific version of application logic that handled the user action at a point in time at which the user action occurred.

This apparatus also includes a temporal database server to couple to the event storage database and to store an in-memory representation of a current state of each of the virtual containers in the application and past states of each of the virtual containers in the application and each change set to transition from each past state to a next state in time up through the current state.

In this apparatus, the application server further includes for each client, a client agent, a subscription bundle, a reality state and a command handler. It should be noted that the functions set forth below that are performed in the specific components in the application server could be moved among other components of the application server without departing from the scope of the present invention.

In this apparatus, the client agent communicates with each client, maintains a list open realities, and accepts incoming command requests, subscription requests and replay control requests.

In this apparatus, the subscription bundle processes the subscription requests by: i) storing metadata about each of the subscription requests; ii) sending a query to the temporal database server containing a criteria from each of the subscription requests, which returns zero or more records; iii) filtering out any returned records that the client has already received; and iv) sending any remaining records as a change set of add changes to the client agent for delivery to the client in a state message, and storing metadata that the subscription bundle has done so.

In this apparatus, the subscription bundle processes change sets from the temporal database server, either change sets newly-generated by commands, or change sets generated from streaming back changes in a replay. The subscription bundle processes the change sets, by: i) breaking each of the change sets into individual changes, which could include an add operation, an update operation and a remove operation; ii) for each individual change, detecting whether the individual change is relevant to any active subscriptions; iii) in some cases, substituting an add or remove operation in place of an update operation; and iv) sending the individual changes to the client agent for delivery to the client in a state message while storing metadata that the subscription bundle has done so.

In this apparatus, the reality state: (i) processes subscription requests; (ii) applies permissions and security logic before handing off the subscription requests to the subscription bundle; (iii) accept change sets from the subscription bundle; and (iv) applies permissions and security logic before returning the change sets to the client agent to send in a message to the client, wherein the reality state may be either a live reality state representing a current state of the application, or a replay reality state representing a state of the application at a past time, and in the case of a replay reality state, the replay reality state extends the subscription requests with a current time of a replay state before passing the subscription requests to the subscription bundle.

In this apparatus, the command handler couples to the event storage database, processes incoming commands and translates the commands into change sets, and sends the change sets to the event storage database for storage therein, which in turn sends the change sets to the temporal database server.

This apparatus also includes a non-transitory computer readable media having stored thereon instructions for a processor to execute a client application to provide a user interface for the clients to interact with the application server. In this apparatus, the client application includes a user interface component, a query engine, a reality state and a server agent. It should be noted that the functions set forth below that are performed in the specific components in the client application could be moved among other components of the client application without departing from the scope of the present invention.

In this apparatus, a user interface component declares a list of queries representing data dependencies of the user interface on data managed by the application server. There could be multiple user interface components depending on the functionality of the client.

In this apparatus, the query engine captures data requirements of the user interface component and updates the user interface component as data changes that affects the user interface component. In this apparatus, the query engine declares subscriptions in response to user interface changes depending on data needed to render the user interface component being displayed on a screen, wherein the subscriptions cause the application server to automatically send updates to the client application when new data matching any subscriptions becomes available or when data is changed or removed which matches any subscriptions.

In this apparatus, the reality state maintains an in-memory representation of a temporal state of the user interface based on state messages sent to the client from the application server. These state messages include a reality identifier and a list of changes, which include operation type, record identifier and data related to the operation. These state messages are sent in response to the subscriptions.

In this apparatus, the server agent communicates with the application server, wherein each reality state communicates with the application server via the server agent, and wherein for every subscription executed, the reality state sends a single subscription message to the application server, receives zero or more state messages in response to the single subscription message, receives a single result message from the server, and may receive sporadic additional state messages as further updates to data related to the subscription occur.

In this apparatus, the application server supports multiple temporal contexts to enable different user interface components of the clients to display different states of the application at different historical times.

In this apparatus, the control signals from the client applications, along with all data requirements, are synchronized to the application server, which then controls streaming of data to the clients.

In this apparatus, when the temporal database server starts up, the temporal database server may request a history of change sets from the event storage database to build up the enterprise software communications platform and the one or more virtual containers being managed thereon.

In this apparatus, the temporal database server may include multiple worker processes, each of which worker processes runs in a different operating system process to allow for distribution of requests across separate processes to utilize multiple CPU cores.

In this apparatus, the temporal database server may store data as multiple nodes, one node for one or more virtual containers, where each virtual container is contained entirely in one node, in the enterprise software communications platform. The nodes answer questions from the Application Server about the state of the virtual containers at arbitrary points in time. Each node is a worker process. One node is assigned for each CPU core. A node has at least one virtual container.

In this apparatus, when the temporal database server starts, the temporal database server may create multiple worker processes, one worker process for each CPU core, and one node for each of the worker processes.

In this apparatus, each reality state may represents either a current state of the virtual container in the application or a past state of the virtual container in the application at a specific point in time, and each reality state may stream live events, for a current state, or stream back past events, for a past state.

In this apparatus, for past application states, a progress bar is displayed on the user interface with a time scale representing a lifetime of data being shown, where a user can skip around in time, and control playback by pausing, resuming, and changing a playback speed of events.

In this apparatus, when a user interface component is instantiated: a) the list of queries is generated from a user interface component definition, in which each query in the list of queries is defined to include: i) a key name to use to store all returned data from each query in a user interface component state table; ii) an optional list of user interface component properties on which said each query depends; and iii) a function definition to execute logic and return data, wherein each function definition contains: (1) one or more function calls, each of which generate one or more subscriptions, for which results are returned immediately from a current reality state; and (2) optional logic to process data returned from each function call; b) each query in the list of queries is executed as follows: i) each function contained in each function definition of each query is executed; ii) the subscriptions are tracked during execution of each function; and iii) a return value of each function is stored in a user interface component state using the key name provided in the query definition; c) each subscription generated in the query execution is subscribed to, such that each query will be re-executed whenever the subscription becomes invalidated; d) a property change listener is generated for any property changes to the user interface component, which property change listener re-executes the query anytime any of the user interface component properties provided in the query definition changes; and e) a removal listener is generated to be notified of a removal of the user interface component, in which case, the removal listener removes all of the subscriptions and query metadata as well related to the user interface component.

In this apparatus, the temporal database server may store data in several nodes, each node storing all historical states of any number of virtual containers within the enterprise software communications platform. In this case, each node stores a number of snapshots of the virtual container within the enterprise software communications platform at particular points in time and change sets that transition from prior snapshots in time to snapshots at newer points in time.

In this apparatus, each snapshot includes a change set applied after a previous snapshot, a time at which the change set occurred, a lookup table of active records by identification, and data storage for indexes to speed up queries for subsets of active records.

In this apparatus, the temporal database server may store data in the nodes in a persistent immutable data structure.

In this apparatus, the temporal database server may store a persistent lookup table of active records using a hash array mapped trie, in which a key is a record identification and a value is a record.

In this apparatus, the temporal database server may store a persistent lookup table for each segment in each index using a hash array mapped trie, in which a key is a possible index value and a value is a set of record identifications.

In this apparatus, the temporal database server may store a persistent sorted list of record identifications in indexes.

In this apparatus, when the temporal database server receives a query, the following steps may occur: determining by the temporal database server which virtual container the query concerns, wherein each virtual container relates to one project, workspace, workplace, unit or other segment being managed by the enterprise software communications platform; determining which worker process stores the node for each virtual container determined using metadata stored in the temporal database server; routing by the temporal database server the query to the determined worker process using a map-reduce system to wait until all results are received; receiving the query by the worker process so determined and locating by the worker process an appropriate node to service the query; calling by the worker process a query handling procedure on the appropriate node; locating by the appropriate node a snapshot closest to a time requested in the query, if no time was requested, using a current time, wherein a closest snapshot is defined by a snapshot that has a closest time with a time less than or equal to a request time; and processing by the appropriate node the query. If the query was of a type “find-by-id” the appropriate node looks up a record using a provided record id and returns it. If the query was of a type “find” the appropriate node: i) analyzes a query criteria to locate a matching index; ii) retrieves a list of record identifiers for the query criteria; iii) iterates through the list of record identifiers, retrieves a corresponding record for each, and tests the corresponding record against the query criteria; and iv) returns records passing the query criteria. Once the appropriate node is finished, the results from the nodes are aggregated by each of the worker processes and sent to the temporal database server. Then, the temporal database server further aggregates the results from the worker processes by and returns the aggregated results.

In this apparatus, when a replay data request is received by the temporal database server, the following steps may occur: analyzing the replay data request to determine which virtual container it concerns; determining which worker process stores a node for each virtual container determined using metadata stored in the temporal database server; routing the replay data request to the worker process so determined using a map-reduce system to wait until all results are received; receiving by each of the worker processes the replay data request and locating the appropriate nodes to service the replay data request; calling by the worker processes a replay data request handling procedure on each of the appropriate nodes; locating by each of the appropriate nodes a range of snapshots closest to the time requested in the replay data request, wherein the replay data request includes both a desired start and an end time, and a closest snapshot to the desired start time is defined by a snapshot that has a closest time with a time greater than or equal to a request time and a logic for finding a closest snapshot to the end time is reversed; retrieving by each of the appropriate nodes a change set contained in each snapshot, and returning an array of change sets as a result; first aggregating returned results from the appropriate nodes by each of the worker processes and sending an aggregated result to the temporal database server; and second aggregating by the temporal database server aggregated results from the worker processes and returning a result of the second aggregating as a result to the replay data request.

In this apparatus, when the server agent receives a state message, the following may occur: a) the reality is located using the reality identifier contained in the state message; b) a change set in the state message is retrieved and sent to the reality for processing; c) a list of affected record identifiers is extracted from the change set in the state message; d) each active subscription contained in a current reality is analyzed to check if the active subscription contains an affected record identifier, and if so an affected active subscription is flagged for invalidation;

e) each change in the retrieved change set is applied; i) if an add operation, a new record is added to the in-memory state; ii) if an update operation: 1) an existing record is located in the in-memory state using a record identifier; 2) updates contained in the retrieved change are applied to the existing record thereby generating a new record; and 3) the new record is stored in the in-memory state, overwriting the existing record; and iii) if a remove operation, a record corresponding to the record identifier is removed from the in-memory state; f) each active subscription contained in a current reality is analyzed to check if the active subscription contains an affected record identifier, and if so, the active subscription is flagged for invalidation; g) each flagged active subscription that was flagged for invalidation has its invalidation logic run, which calculates the active component queries for that subscription, and re-executes those queries, causing the relevant user interface component to receive state updates; h) if a state message contained metadata regarding a percentage completion of an active replay in the reality, the percentage completion is updated; and i) the user interface component is re-rendered if its state changed during this process.

In this apparatus, when the command handler generates a change set, the following may occur: a) the change set is stored in the event storage database; b) the change set is sent to the temporal database server to be applied to a current state representation and an historical system state representation; c) the change set is published to the clients by: i) the change set is published to the application server, which evaluates the change set with regards to each open client connection; ii) for a given change set and an open client connection, the application server compares each change in the change set against the active subscriptions contained in the open client connection, and if the change matches an active subscription, the application server adds the change to a queue for the open client connection.

According to still another aspect of the present invention, an exemplar embodiment of an apparatus to enable an application executing on an application server to store and replay past states of virtual containers being managed by the application includes an event storage database, a temporal database server, and a client application.

In this apparatus, the event storage database stores: i) user commands, which capture user action and data associated with the user action; and ii) change sets, which include a result of processing the user action in a format that can be stored without processing any further logic or needed access to a specific version of application logic that handled the user action at a point in time the user action occurred.

In this apparatus, the temporal database server is coupled to the event storage database and stores an in-memory representation of a current state of each of the virtual containers and past states of each of the virtual containers and each change set to transition from each past state to a next state up through the current state.

In this apparatus, a non-transitory computer readable media has stored thereon instructions for a processor to execute the client application, which provides a user interface with which the application may interact. The client application includes several components, such as a user interface component, a query engine, a reality state and a server agent. Other components may be included in the client application (for example, such as those that relate to other core functions of the specific application) but these components are those necessary for the replay feature as described above. It should be noted that the functions set forth below that are performed in the specific components in the client application could be moved among other components of the client application without departing from the scope of the present invention.

In this apparatus, the user interface component declares a list of queries representing data dependencies of the user interface on data managed by the application. There may be multiple user interface components depending on the specifics of the application.

In this apparatus, the a query engine captures data requirements of the user interface component and updates the user interface component as data changes that affects the user interface component. The query engine declares subscriptions in response to user interface changes depending on data needed to render the user interface component being displayed on a screen. These subscriptions cause the application to automatically send updates to the client application when new data matching any of the subscriptions becomes available or when data is changed or removed which matches any of the subscriptions.

In this apparatus, the reality state maintains an in-memory representation of a temporal state of the user interface based on state messages sent to the client from the application. Each state message includes a reality identifier and a list of changes (including operation type, record identifier and data related to the operation). Each state message is sent in response to one subscription.

In this apparatus, the server agent communicates with the application. Each reality state communicates with the application via the server agent, and for every subscription executed, the reality state sends a single subscription message to the application, receives zero or more state messages in response to the single subscription message, receives a single result message from the application, and may receive sporadic additional state messages as further updates to data related to the subscription occur;

In this apparatus, the temporal database server stores and creates multiple temporal contexts to enable different user interface components to display different states of the application at different historical times.

According to still another aspect of the present invention, an exemplary embodiment of a method is disclosed for storing and replaying one or more past states of one or more virtual containers whose data is being managed by an application being executed on an application server coupled to one or more clients. The application enables users of the clients to communicate amongst each other and to collaborate within virtual containers.

The method includes: storing in a database user commands, each of which captures user action and data associated with the user action; storing in the database change sets, each of which includes a result of processing the user action in a format that can be stored without processing any further logic or needed access to a specific version of application logic that handled the user action at a point in time at which the user action occurred; storing in a database server an in-memory representation of a current state of each virtual containers and past states of each of the virtual containers and each change set to transition from each past state to a next state in time up through the current state; and providing a user interface for at least one client to interact with the application server. In this method, the user interface may have one or more user interface components.

This method further includes: declaring a list of queries representing data dependencies of the user interface on data managed by the application server; capturing data requirements of the user interface component and updating the user interface component as data changes that affects the user interface component; declaring subscriptions in response to user interface changes depending on data needed to render the user interface component being displayed on a screen; causing the application server in response to the subscriptions to automatically send updates to the client application when new data matching any of the subscriptions becomes available or when data is changed or removed which matches any of the subscriptions; maintaining as a reality state an in-memory representation of a temporal state of the user interface based on state messages sent to the client from the application server, wherein each state message includes a reality identifier, a list of changes including operation type, record identifier and data related to an operation and each state message is sent in response to one of the subscriptions; sending, for every subscription executed, a single subscription message to the application server; receiving zero or more state messages in response to the single subscription message; receiving a single result message from the application server; receiving one or more sporadic additional state messages as further updates to data related to the subscription occur; and supporting multiple temporal contexts to enable different user interface components of the clients to display different states of the virtual container at different historical times.

This method may include: synchronizing control signals from the client applications, along with all data requirements, to the application server; and controlling streaming of data to the clients by the application server.

This method may also include: maintaining a list of open realities in the application server; accepting incoming command requests, subscription requests and replay control requests by the application server; processing subscription requests by the application server; processing change sets from the database generated from commands or generated from streaming back changes in a replay state; accepting change sets by the application server and returning the change sets in a message to the clients; processing incoming commands and translating the commands into change sets; and sending the change sets to the database for storage therein, which in turn sends the change sets to the database server.

In this method, the reality state may be either a live reality state representing a current state of the virtual container, or a replay reality state representing a state of the virtual container at a past time. For a live reality state, the reality state: (i) passes subscription requests through to the subscription bundle; and (ii) watches for change sets being generated as incoming commands are processed, and feeds those generated change sets to the subscription bundle.

In the case of a replay reality state, the reality state may pass subscription requests through to a subscription bundle in the application server while extending the subscription requests with a current time of a replay state.

In this method, the replay reality state may be playing or paused. If the replay reality state is playing, the reality state may fetch a list of change sets from the database server every time step by: a) checking a desired number of change sets, given by a current playback speed in a reality metadata; b) creating a list of outgoing change sets; c) if there are no change sets in a change set queue, requesting a batch of change sets from the database server, starting from a last recorded time and advancing a last recorded batch time; d) if there is at least one change set in the change set queue: (i) removing a first change set from the change set queue; (ii) sending the change set to a subscription bundle in the application server for processing; (iii) accepting a returned change set, if any; and (iv) if a change set was returned from the subscription bundle, adding the returned change set to any outgoing change sets; e) if there are enough change sets in the outgoing change sets, sending these change sets to the subscription bundle; and f) if there are not enough change sets in the outgoing change sets, repeating steps c) through e).

In this method, if the replay reality state is paused, the reality state may wait for further subscribe or replay control requests.

In this method, the reality state may process incoming replay control signals by manipulating a state of the replay.

In this method, incoming replay control signals may include: a create reality signal, which creates a reality with a replay in a paused state synchronized to a creation time of the virtual container; a dispose reality signal, which terminates a replay; a play signal, which transitions a replay from the paused state to a playing state; a pause signal, which transitions a replay from the playing state to the paused state; a set replay speed signal, which updates a playback speed in a replay metadata, which is used while playing to determine a number of change sets to return; and a seek signal, which given a desired percentage of completion of the replay, sends necessary changes to skip to a desired replay completion.

In this method, upon receipt of a seek signal the reality state may: retrieve a desired completion percentage from a metadata in the seek signal; converts the desired completion percentage into a converted time; retrieve a list of change sets from the database server from a current replay time to the converted time; send each change set to a subscription bundle in the application server and collect all results; update a current time in the replay metadata; and send all resulting change sets to a client agent in the application server.

In this method, a subscription bundle in the application server may process the subscription requests by: a) storing metadata about each of the subscription requests; b) sending a query to the database server containing a criteria from each of the subscription requests, which returns zero or more records; c) filtering out any returned records that said each client has already received; and d) sending any remaining records as a change set of add changes to each client agent in the application server for delivery to said each client in a state message, and storing metadata that the subscription bundle has done so.

In this method, a subscription bundle in the application server may process the change sets by: a) breaking each of the change sets into individual changes, including an add operation, an update operation, or a remove operation; b) for each individual change, detecting whether said each individual change is relevant to any active subscriptions; c) in some cases, substituting an add or remove change in place of an update change; and d) sending the individual changes to the client agent for delivery to the client in a state message and storing metadata that the subscription bundle has done so.

Other aspects of the present invention will be apparent to those of skill in the art in which the present invention relates upon review of the following drawings and discussion.

### BRIEF DESCRIPTION OF THE DRAWINGS

FIG. 1 depicts a schematic block diagram of a computer network in which embodiments of the present invention may operate according to one aspect of the present invention.

FIG. 2 depicts a diagram of one possible internal structure of a computer (e.g., computer) or server in the system of FIG. 1 according to another aspect of the present invention.

FIG. 3 depicts a representation of one possible client server architecture, representing the flow of commands and data within the system according to yet another aspect of the present invention.

FIG. 4 depicts a representation of one possible application server architecture, representing the flow of commands and data within the system according to still another aspect of the present invention.

FIG. 5 depicts a representation of an example of how a persistent data structure changes when updates are applied according to yet another aspect of the present invention.

FIGS. 6-10 depict user interface screen shots of an exemplary embodiment of an enterprise software communications platform to which the present invention is directed according to yet another aspect of the present invention.

FIGS. 11a-c depict an exemplary embodiment of a method for storing and replaying past states of virtual containers whose data is being managed by an application being executed on an application server coupled to several clients according to still another aspect of the present invention.

FIGS. 12a-b depict an exemplary embodiment of possible other steps of the method in FIG. 12 according to yet another aspect of the present invention.

FIG. 13 depicts an exemplary embodiment of a method for processing by a reality state in an application server in the case of a live reality according to still another aspect of the present invention.

FIGS. 14a-c depict an exemplary embodiment of a method for processing by a reality state in an application server in the case of a replay reality according to yet another aspect of the present invention.

FIG. 15 depicts an exemplary embodiment of a method for processing by a reality state in an application server in the case of a seek signal according to still another aspect of the present invention.

FIG. 16 depicts an exemplary embodiment of a method for processing subscription requests by a subscription bundle in an application server according to yet another aspect of the present invention.

FIG. 17 depicts an exemplary embodiment of a method for processing change sets a subscription bundle in an application server according to still another aspect of the present invention.

FIG. 18 depicts an exemplary embodiment of an enterprise software communications platform according to yet another aspect of the present invention.

### DETAILED DESCRIPTION

### Overview

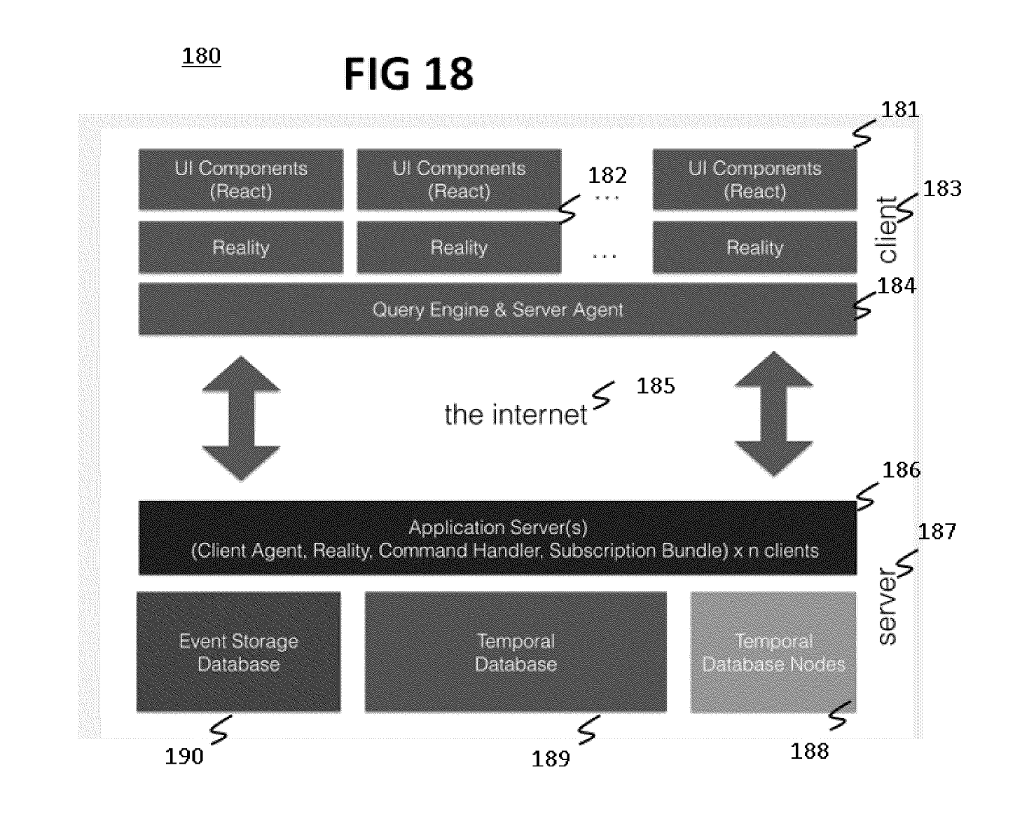

Turning to FIG. 18, shown therein is an exemplary embodiment 180 of the present invention which comprises an enterprise software communications platform (termed herein as “Dashcube”) that enables users to communicate with each other via voice, video and text as well as to share and track metrics dashboards and project tasks. The client 183 is coupled to the server 187 over the Internet 185 or other public or private network.

The user interface of Dashcube consists of components 181 written in a JavaScript framework called React. These components 181 have their data attached to a particular application state, called a Reality 182. The state of the cube data now is “Current Reality”, and previous states of the cube data which can be accessed through the Replay system are “Replay Realities”. The Dashcube user interface can display the Current Reality and an arbitrary number of Replay Realities at the same time by hooking up the various realities to various sets of user interface components. The way that the various Realities 182 get their data is via the Query Engine 184. Each Reality in the Dashcube Client 183 communicates over the Internet 185 with the Application Server 187 via a Server Agent 184, which uses the Query Engine.

On the Application Server side 187, there is one Client Agent 186 for each Server Agent. It is the job of the Client Agent 186 to act on behalf of the client. The Application Server 187 also maintains a Reality for each client. The Command Handlers receive command messages from the Client Agent, which passes the commands along for the Server Agent in the user interface. Subscription messages are sent to the server on initial application load, as well as in response to user interface changes, depending on what data is needed to render the UI components displayed on the screen. A Subscription Bundle tracks active Subscriptions and synchronized record state for a Client, for either the current application state or a past state. The Subscription Bundle processes new Subscription requests, and filters Change Sets against the set of active Subscriptions.

In order to service Subscription and Replay requests, the server must be able to process queries about application state at any point in time, as well as be able to retrieve and stream data changes between multiple points in time. To do this, a Temporal Database Server 189 builds up an efficient in-memory representation of all past application states as well as tracking data changes to transition from state to state. When the Temporal Database Server 189 starts up, it requests the history of Change Sets from the Event Storage Database 190, and uses the Change Sets to build up the in-memory representation of the temporal data using a series of “snapshots” of historical states of the system, using persistent immutable data structures to reduce total memory usage, thus achieving concurrent representation of thousands of application states only using the memory cost of a few application states.

The Temporal Database Server 189 contains Temporal Database Nodes 188. The job of the Temporal Database Nodes 188 is to answer questions from the Application Server about the state of the cubes at arbitrary points in time. Each node is a worker process. One node is assigned to each CPU core. A node has at least one cube, there may be hundreds of cubes for one node (for small cubes that is definitely the case). The number of nodes is dependent on the hardware, as spinning up more than one node per process is wasteful. The way the cubes are distributed among the nodes is by using a least-loaded node strategy. The Event Storage Database is the place where the Change Sets are stored in permanent storage. The Event Storage Database can be implemented as a Mongo Database or any other type of memory or database.

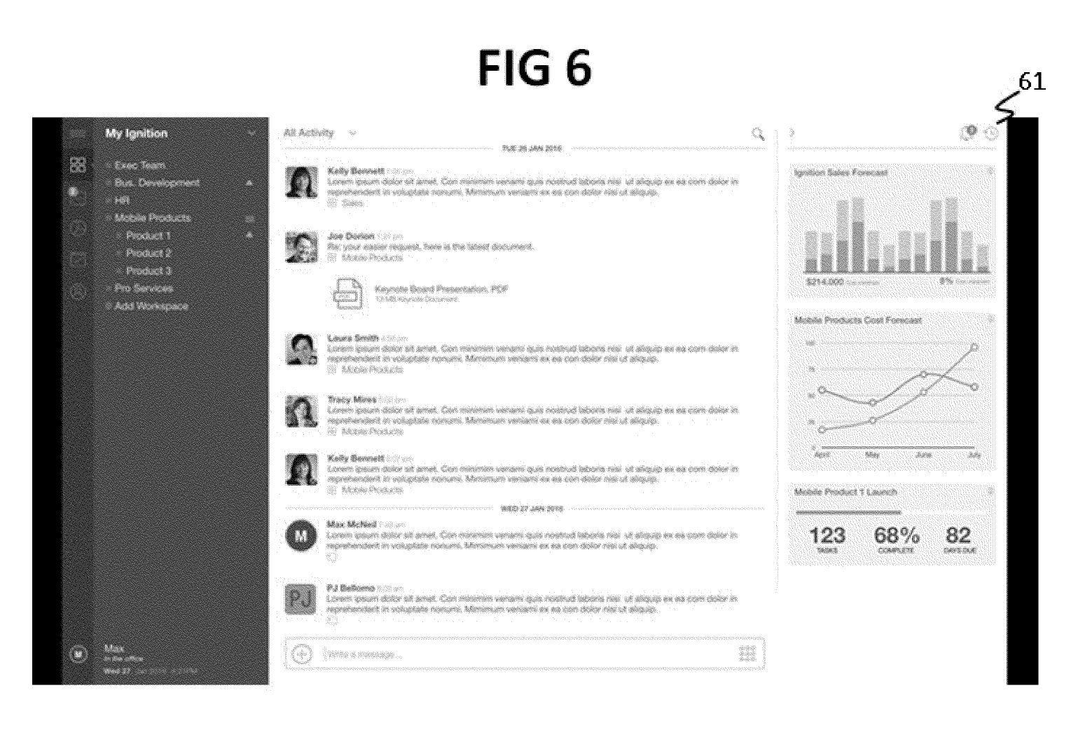

Examples of the user interface for Dashcube are shown in FIGS. 6-10. For scope and language clarity, while most systems readily consider voice, video and text as communication forms, the Dashcube platform also includes task descriptions and dashboards as communication forms. Within Dashcube, all communication functions and related data reside within virtual containers referred to as “Cubes.” The enterprise software communications platform of the present invention manages multiple Cubes simultaneously and multiple users collaborating within each Cube. The precise nature of the communications and collaboration is not necessary to the present invention, as the present invention can be applied to any communication interactions between groups of people and devices or systems, including but not limited to entire enterprises, project developments, user groups, employee units, or any interactive group. Much of the description herein will describe this platform in relation to one virtual container or project for simplicity purposes, and where appropriate will discuss features of the architecture that enable the design to support multiple virtual containers or projects.

One aspect of the present invention includes the replay feature, i.e., the ability to go back in time and view past states of Cubes as well as to “play back” the history of a Cube. It is possible to dynamically revisit any point in time in the history of a Cube since it was created, and inspect any of the information contained within it, simply by dragging a time slider to the time in the history of the Cube's lifetime that you wish to inspect. From that point, you may play changes forward at a selection of playback rates, pause playback, and skip around in time.

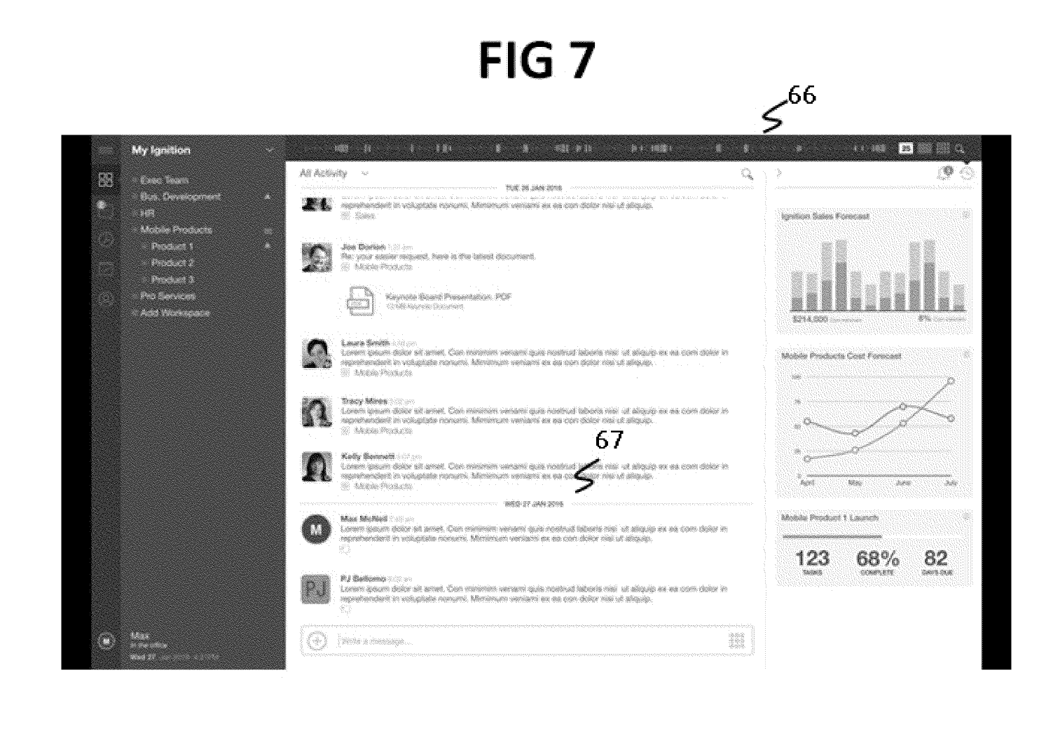

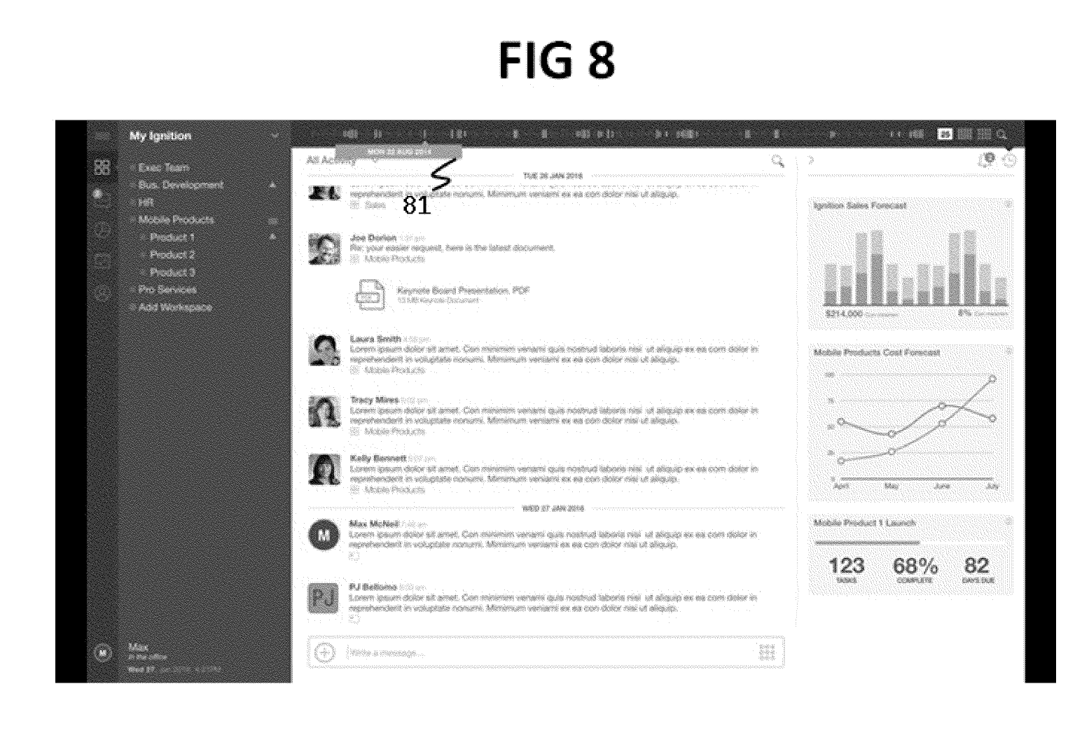

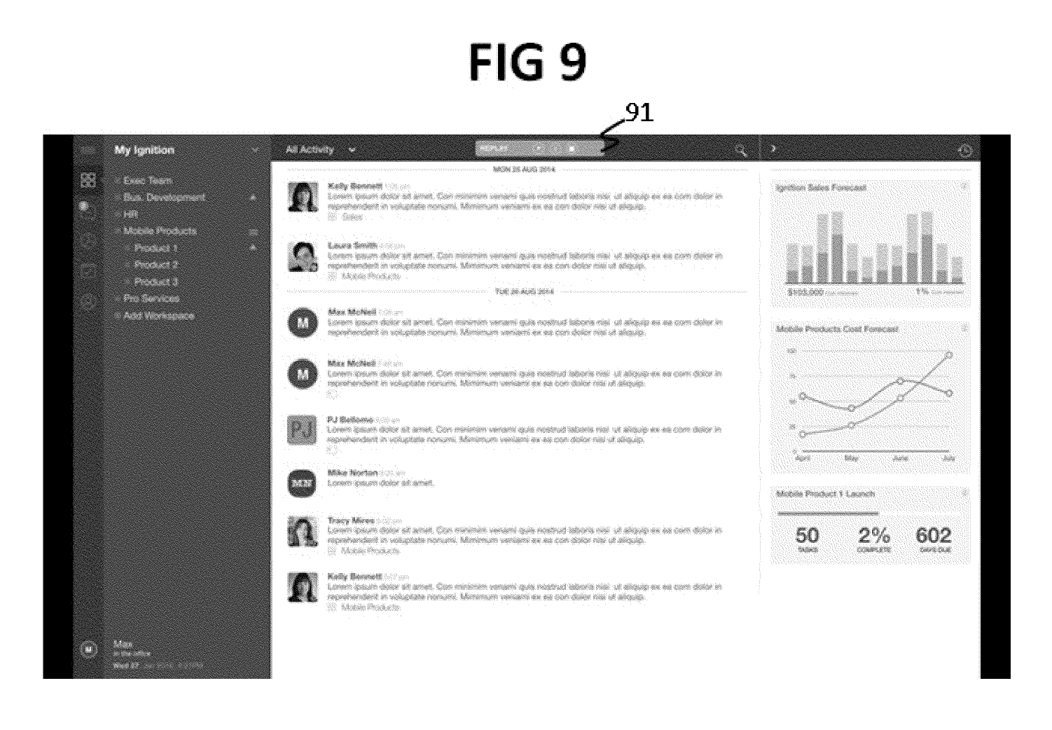

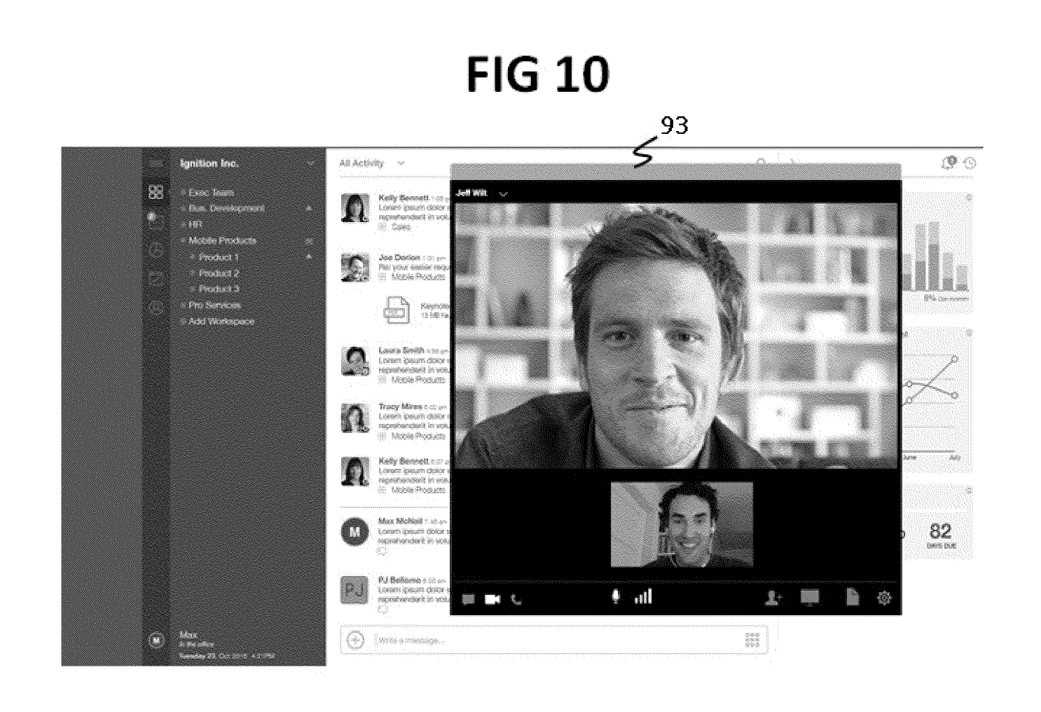

FIGS. 6-10 depict user interface screen shots of an exemplary embodiment of an enterprise software communications platform to which the present invention is directed according to yet another aspect of the present invention. For example, FIG. 6 is illustrative of the system state as of Wed 27 Jan. 2016. (See “clock replay icon” 61). FIG. 6 exemplifies how the enterprise software communications platform presents a jump-back-in-time clock icon 61, allowing a user to initiate a reset of a virtual container to a historical system state. In FIG. 7, the replay icon is activated on Wed 27 Jan. 2016 (see element 67). FIG. 7 depicts how the system offers a user a timeline 66 with allowable prior reset dates. In FIG. 8, the user choses to reset the system to Mon 22 Aug. 2014 (see element 81). FIG. 8 depicts a user selecting a specific date in time to reset the virtual container. In FIG. 9, the system state was reset to Mon 25 Aug. 2014 and the Replay Function is available (see elements 91). FIG. 9 depicts how a user remains logged-in (lower left) on the current date, but the system message stream (middle column) and dashboard (right column) reset to the earlier system date. FIG. 9 also depicts how the system provides “play,” “pause” and “stop” controls by which a user can replay the data in the virtual container. FIGS. 6-8 exemplify how a user can activate the replay feature by opening a timeline feature and resetting a virtual container to an earlier point in time, with the user interface resolving and displaying data as of the prior state. FIG. 9 provides the user with playback controls (see element 91). FIG. 10 exemplifies how a user might respond to enterprise messaging activity by choosing to activate the video communications component 93 and proceed with a video call as shown in the screen shot.

The implementation of the replay feature requires an innovative client-server protocol, a unique client architecture, a custom event processing and storage system, and a novel “temporal” database server to allow efficient retrieval and streaming of replay data. The programming logic, business rules and processes described are not specific to the communications and enterprise collaboration market segment, nor are they specific to the programming language or transport protocol used herein. Certain novel components of Replay include the methods for capturing, storing, retrieving, and playing back historical application state, and how all of these components interact, as well as the innovative client/server protocol.

In order to cope with live updates and replay playback, the client architecture contains a novel mechanism termed the “Query Engine” which lets the UI create subscriptions which automatically update when the data returned by the query changes. This system is comprised of a declarative syntax on components to define data requirements, and a series of code modules that track data requirements, broadcast them to the server via the Server Agent, and notify components when data changes. In order to show different temporal contexts at the same time, e.g., to simultaneously show the data that exists for a Cube right now, as well as three months ago and two years ago, a system of “Realities” exists. The Reality system interacts with the server via a Server Agent module which creates subscriptions and replay control signals. So, one aspect of the present invention combines subscriptions and/or queries with a system for constructing data requirements for subscriptions based on any number of arbitrary temporal contexts using a declarative syntax.

In order to support the playback and analysis of past events, Dashcube needs to not only collect the data and metadata from the initial user action causing the event, but also the effects of the event. If the effects are not captured at the time the event occurs, it would become very difficult to process old events after changes to the application business logic have taken place. Commands are handled by a Command Handler which validates security and data integrity rules and then translates the command into a series of data update operations called a Change Set. This Change Set is stored on disk (such as a Mongo Database, but other types of storage systems are within the scope of the present invention) and also sent to the Temporal Database and published to connected clients. The Temporal Database keeps a novel in-memory representation of the temporal data using a series of “snapshots” of historical states of the system, using persistent immutable data structures to reduce total memory usage, thus achieving concurrent representation of thousands of application states only using the memory cost of a few application states.

The present invention enables managers and users to better understand the status of enterprise activities and metrics at any point in time by replaying the platform communication states over time, which surfaces patterns in dashboards, tasks and other communication elements. To engage with the system to replay something, the user clicks a button in the user interface (UI) to enter replay mode. This switches the UI into replay mode, but looking at the same information that is currently being presented (e.g., the tasks in a project, the communication on a sub-project, etc.).

According to one embodiment of the present invention, the replay system shows a time control which uses a progress bar user interface metaphor, which is similar to the time controls on online video sites such as YouTube. The beginning of time, shown at the left side of the time control, is the time when the parent cube was created. (A cube is the virtual container or thing which contains the projects, sub-projects and all of their tasks and communications.) The end of time, shown at the right side of the time control, is the present time. Within the time control, time is spaced evenly. The user can grab and drag a user interface affordance in the time control to adjust what time is being displayed. When the dragging stops, the system updates the data to show the data as it was at that given time. This lets a user look into how they saw the tasks and communication in the project at that time in the past. The user can click a play button to see the project unfold in a replay. Replay speed is defined in a number of events per second.

An event is a task creation, a message, a dashboard update, etc. When events are played back, the user interface is updated to show the events happening. The user interface is in read-only mode during replay (after all, one cannot change the past), but it is fully interactive: every task, message and dashboard can be selected and viewed. Depending on the type of communication element Cube contents may be visualized with optimal view modes. For example, projects can be viewed as task lists, Kanban boards, tree maps, calendars, etc. Furthermore, any dashboard visualizations that are defined based on “current” data will be updated during a replay, since a replay literally modifies what “current” is. This is why the application states are termed “Reality” states: when doing a replay, the client is constructing a reality based on how the cube data existed in the past.

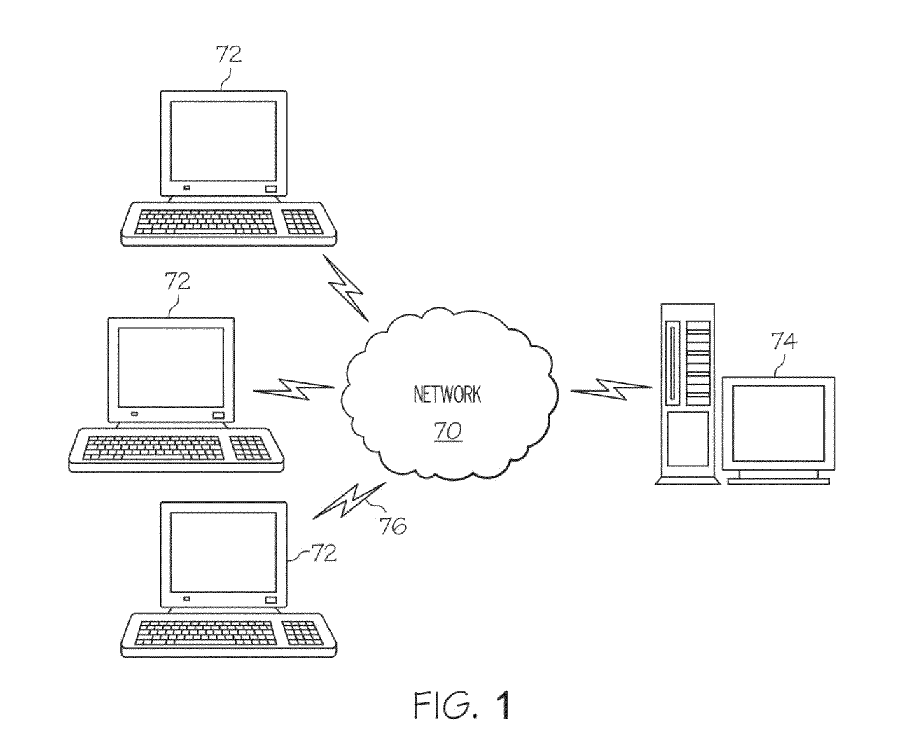

Turning to FIG. 1, shown therein is a schematic block diagram of a computer network in which embodiments of the present invention may operate. Computers 72 and server 74 provide processing, storage, and input/output devices executing application programs and the like. Computers 72 may be linked over communication link 76 through communications network 70 to each other and to other computing devices, including servers 74. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 72 and servers 74 may be linked over any suitable communication network. In the system of FIG. 1, for example, a collaboration system implementing an embodiment of the invention could reside on server 74 and organizers and users could interact with the collaboration system using computers 72.

In addition to the client-server arrangement of FIG. 1, embodiments of the invention may operate in any client-server arrangement or in any networked arrangement in which resources that originate communications and resources that receive communications may reside on separate elements in a network. For example, embodiments of the invention may operate in a mobile communications/data architecture (such as a mobile telecommunications network adhering to the International Mobile Telecommunications-2000 (also termed 3G) or IMT-Advanced (also termed 4G) standards), in which a mobile telecommunications device (e.g., cell/mobile telephone) communicates.

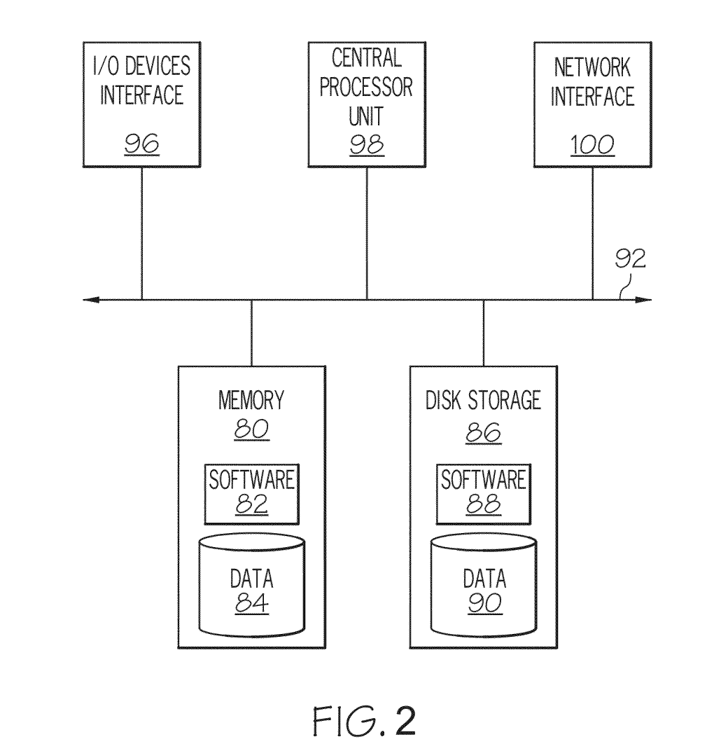

Turning to FIG. 2, shown therein is a diagram of one possible internal structure of a computer (e.g., computer 72) or server in the system of FIG. 1. Each computer typically contains system bus 92, where a bus is a set of hardware lines used for data transfer among the components of a computer. Bus 92 is essentially a shared conduit that connects different elements of a computer system (e.g., processor, disk storage, memory, input/output ports, network ports, etc.) that enables the transfer of information between the elements. Attached to system bus 92 is I/O device interface 96 for connecting various input and output devices (e.g., displays, printers, speakers, microphones, etc.) to the computer. Alternatively, the I/O devices may be connected via one or more I/O processors attached to system bus 92. Network interface 100 allows the computer to connect to various other devices attached to a network (e.g., network 70 of FIG. 1). Memory 80 provides volatile storage for computer software instructions 82 and data 84 used to implement an embodiment of the present invention. Disk storage 86 provides non-volatile storage for computer software instructions 88 and data 90 used to implement an embodiment of the present invention. Central processor unit 98 is also attached to system bus 92 and provides for the execution of computer instructions. Embodiments of the present invention may include a system, a method, and/or a computer program product.

The computer program product may include a computer readable storage medium (or media) having computer readable program instructions thereon for causing a processor to perform aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatuses to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatuses, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Dashcube

Dashcube is a communications platform, encompassing classic enterprise communication functions and forms, such as text voice and video, as well as metrics dashboard, task lists, projects and people directories. Dashcube enables participate to communicate between and amongst each other and to share information, such as files, project plan and dashboards. In Dashcube, a “Cube” is a central construct, used by a team for project planning and communication. In Dashcube, a “Cube” is a central construct, used by a team to circumscribe communications. A cube is essentially a virtual container for all data related to the communications for which the cube is created. Users of Dashcube subscribe to one or more Cubes depending upon the scope of their enterprise work and responsibilities, with new Cubes being created such things as new departments, projects, initiatives, etc. Dashcube records all communications and developments within Dashcube to a Cube.

Dashcube provides the ability to perform a “Replay” function to review prior communications. In other words, Replay is the ability to go back in time and view past states of Cube components, such as projects, and “play back” the history. The present invention makes it possible to re-visit any point in time in the history of a Cube (e.g., a point in time on a project) since the Cube was created, and inspect any of the information contained within the Cube. From that point, a user may play changes forward at a selection of playback rates, pause playback, and skip around in time similarly to the way one might playback a digital video recording.

According to one aspect of the present invention, an exemplary embodiment of the replay feature employs an innovative client-server protocol, a unique client architecture, a custom event processing and storage system, and a novel “temporal” database to allow efficient retrieval and streaming of replay data. These elements of the exemplary embodiment will be discussed in detail below.

While the Replay feature will be discussed herein in terms specific to Dashcube, the algorithms, methods and techniques described herein could also be applied to any data-oriented software system. The algorithms, methods and techniques described herein are not specific to enterprise communications, project management or team collaboration implementations, nor are they specific to the programming language or transport protocol discussed herein. Certain novel components of Replay include the algorithms for capturing, storing, retrieving and playing back historical application state, as well as the innovative client/server protocol.

Dashcube includes web, iOS, and Android applications along with a cloud-based server cluster to store data and service clients. All of these applications utilize the same client-server protocol, which comprises a small number of JavaScript Object Notation (JSON)-format Hyper Text Transport Protocol (HTTP) end-points, and a custom application protocol using JSON-format messages over the WebSocket protocol.

An embodiment for a web application will be described herein that implements the Replay feature, hence the Client-specific sections herein will focus on this web application implementation. However, the replay features may also be implemented in iOS and Android clients, in which case the same algorithms will be used and the components will be organized in a similar manner.

Client-Server Protocol

Overview

The Dashcube Client-Server protocol comprises:
1. An HTTP Application Programming Interface (API) used for account creation and authentication, as well as third-party service integrations.
2. A WebSocket protocol used by the client applications while authenticated.

The API is not relevant to the Replay feature implementation, but the WebSocket protocol comprises part of the Replay implementation.

The primary client-server protocol is built using JSON-format messages sent and received over a RFC-6455-compliant WebSocket connection. However, the messages described below are both transport-agnostic and data-format-agnostic, and apply to any transport or data format (for example, they could be implemented in a Windows desktop application using a binary format and TCP connection).

The protocol messages fall into a variety of categories:
1. Connection negotiation and maintenance;
2. “Commands” and responses (requests to make changes to the data);
3. “Subscriptions” and responses (requests to retrieve segments of data and be notified of changes);
4. Replay control signals; and
5. Messages specific of other features in the application.

While only categories (3) and (4) are needed to implement Replay functionality itself, category (2) is important in understanding the data format of the underlying system.

Commands

Command messages are sent to the server whenever a user interacts with the application in a manner that requires creation, removal, or modification of any data persisted by the server. Examples include:
Creating a new task;
Changing the priority of a task;
Writing a message about a task;
Sending a private message to another user;
Changing personal settings in the application; and
. . . and hundreds of other use cases.

Commands consist of two kinds of messages:
1. “Command” messages sent from the client to the server, containing:
   The type of user action (e.g., task creation);
   Any data relevant to command type (e.g., name, description, and priority of task); and
   A correlation identifier to use to identify the response from the server.
2. “Result” messages received by the client from the server, containing:
   Indication of success or failure;
   Result(s) from the command, if applicable (most commands do not return direct results);
   Information about the error, if the command failed; and
   The same correlation identifier as the first message.

For every Command executed, a client sends a single command message and receives a single response from the server.

Example Command Message:

{

“type”:“cmd”,
“params”:{

“type”:“CreateTask”,
“data”:{

“parentId”:18,
“assigneeId”:3,
“name”:“Database backup script”,
“description”:“Create an automated nightly

backup.”
}

},
“cid”:150

}
Example result message:
{

“type”:“res”,
“params”:{

“err”:null,
“result”:922234

},
“cid”:150

}

Subscriptions

Subscription messages are sent to the server on initial application load, as well as in response to User Interface (UI) changes, depending on what data is needed to render the UI components displayed on the screen. The specifics of how these Subscriptions are created will be addressed in the Client Architecture section, but for now it is important to detail the purpose and mechanics of Subscriptions.

Subscriptions are used to retrieve the necessary data from the server to show information in the UI, and are also responsible for automatically sending updates when new data matching a Subscription becomes available (as well as when data is changed or removed).

There are two types of subscriptions:
1. “Find” Subscriptions specify a type of record to retrieve along with criteria to use to filter the set of records of that type; and
2. “Find-by-id” Subscriptions specify a record identifier, to retrieve a single record.

Subscriptions Consist of Three Kinds of Messages:
1. “Subscription” messages sent from the client to the server, containing:
   The type of subscription (either find or find-by-id);
   The “Reality” identifier that the subscription applies to (see Replay Control Signals section below);
   If find:
      i. the type of records to return;
      ii. The criteria to use to search for records (using MongoDB query syntax, for example); and
      iii. Options such as sort ordering, or a limit on the number of results;
   If find-by-id:
      i. The identifier of the desired record; and
   A correlation identifier to use to identify the response from the server.
2. “State” messages received by the client from the server, containing:
   The “Reality” identifier that the state message applies to (see Replay Control Signals section below);
   A list of changes, each including:
      i. The operation type: add, update, or remove;
      ii. The record identifier;
      iii. If add, the full record data; and
      iv. If update, a change format specifying the update to that record (using a subset of the MongoDB update syntax); and
   Optional metadata about the change. In non-replay messages, this is empty. In Replay messages, it contains information about the progress of the Replay (for example, a single number representing the Replay completion percentage).
3. “Result” messages received by the client from the server, containing:
   Indication of success or failure;
   The number of results returned, if the command succeeded;
   Information about the error, if the command failed; and
   The same correlation identifier as the first message.

For every Subscription executed, a client sends a single subscription message, receives zero or more subsequent state messages, and then receives a single result message from the server. Afterwards, the client may receive sporadic additional state messages as further updates to the data occur.

Example Find Subscription Message:

{

“type”:“sub”,
“params”:{

“realityId”:0,
“type”:“task”,
“criteria”:{

“parentId”:18

},
“opts”:{
}

},
“cid”:1565

}

Example Find-by-Id Subscription Message:

{

“type”:“subId”,
“params”:{

“realityId”:0,
“id”: 922234

},
“cid”:2197

}

Example State Message:

{

“type”:“state”,
“params”:{

“realityId”:0,
“changes”:[

{

“op”:“add”,
“type”:“task”,
“id”:922234,
“ver”:1,
“data”:{

“parentId”:18,
“assigneeId”:3,
“name”:“Database backup script”,
“description”:“Create an automated

nightly backup.”,

“done”:true,
“cubeId”:18

}

},
...additional changes...

],
“metadata”:{ }

}

}

Example Result Message:

{

“type”:“res”,
“params”:{

“err”:null,
“result”:1

},
“cid”:1565

}

Replay Control Signals

Replay Control signals are used to create and control Replays in the client. Signals include:
“createReality”—Creates a Reality with a Replay in the paused state synchronized to the creation time of the current Cube.
“disposeReality”—Terminates a Replay.
“play”—Transitions a Replay from the Paused state to the Playing state.
“pause”—Transitions a Replay from the Playing state to the Paused state.
“setReplaySpeed”—Updates the playback speed in the Replay metadata (which is used while Playing to determine the number of Change Sets to return).
“seek”—Given a desired percentage of completion of the Replay, sends the necessary changes to skip to the desired Replay completion.

Example Signal Message:

{

“type”:“play”,
“params”:{

“realityId”:1

},
“cid”:112

}

Example Result Message:

{

“type”:“res”,
“params”:{

“err”:null

},
“cid”:112

}

Client Architecture

Overview

The Dashcube web client is built in JavaScript, using the React open-source library to create components to contain User Interface state and behavior.

An exemplary embodiment of the present invention includes two important extensions to the React library, that work in concert to provide the Replay functionality:
1. A system to capture data requirements of UI components and mechanism to update those components as data changes (due to either live changes or replay playback). Termed the “Query Engine”, this system is comprised of a declarative syntax on components to define data requirements, and a series of code modules that track data requirements, broadcast them to the server via the Server Agent and notify components when data changes.

Each “Query” performs logic and declares data “Subscriptions”. Each Subscription has one of two types:
a. Find—to subscribe to a set of records of a type, matching certain criteria;
   The type of records to return;
   The criteria to use to search for records (using MongoDB query syntax, for example); and
   Options such as sort ordering, or a limit on the number of results; and
b. Find-by-id—to subscribe to a specific record;
   The identifier of the desired record;
2. A system to extend React components to support multiple temporal contexts, such that different UI components can show data from different time periods, termed “Realities”. Each Reality communicates with the server via the Server Agent module, generating Subscriptions and sending Replay Control signals.
Each Reality represents either current application state or a past state at a specific point in time, and includes streaming of live events (for current state) or streaming back past events (for past states). For past states, a progress bar is shown with a time scale representing the lifetime of the data being shown, where the user can skip around in time, and control playback by pausing, resuming, and changing the playback speed of events. These control signals, along with the data requirements, are synchronized to the server, which then controls the streaming of data to the client.

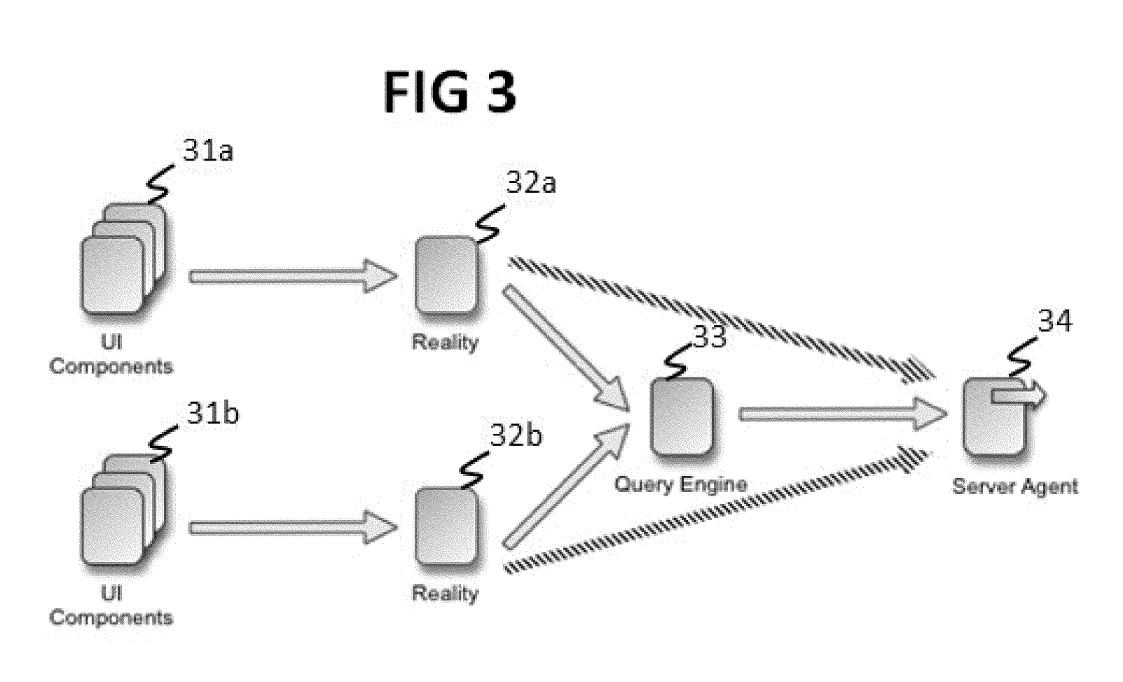

Turning to FIG. 3, shown therein is an exemplary embodiment of a server architecture, in which the flow of commands and data within the system are indicated.

Query Creation and Execution

Each UI component (each of the separate components of 31a or 31b) declares a list of Queries representing its dependencies on server-managed data. When a component is instantiated (or, in React terminology, when a component is “mounted”), the following steps occur:
1. A list of Queries is generated from the component definition. Each Query contains:
   a string representing the name of the key to use to store the returned data from the Query in the component state table;
   an optional list of names of component properties that the Query depends on; and
   a function definition that will execute the Query logic and return data. Each functional definition contains:
      i. One or more function calls that generate Subscriptions, for which results are returned immediately from the current Reality State; and
      ii. Optional logic to process the data returned from the Subscription function calls.
2. Each Query is “executed”:
   The function contained in the Query definition is run;
   Subscriptions are tracked during the function execution; and
   The return value of the function is stored in the component state using the key name provided in the Query definition.
3. Each Subscription generated in the Query execution is “subscribed” to, such that the Query will be re-executed whenever the Subscription in invalidated.
4. A listener is generated for property changes to the component, such that the Query will be re-executed anytime one of the component properties provided in the Query definition changes.
5. A listener is generated to be notified of the removal of the component. If this occurs, it removes all of the Subscriptions and Query metadata as well.

State Update Handling

Each Reality 32a, 32b maintains an in-memory representation of the temporal state received from messages returned from the Server Agent 34. When the Server Agent 34 receives a state message, the following steps occur:
1. The Reality 32a, 32b is located using the reality identifier contained in the State message.
2. The Change Set is retrieved from the State message and sent to the Reality 32a, 32b for processing.
3. A list of affected record identifiers is extracted from the Change Set.
4. Each active Subscription contained in the current Reality 32a, 32b is analyzed to check if it contains an affected record identifier. If so, it is flagged for invalidation.
5. Each Change in the Change Set is applied.
   a. If an add operation, the record is added to the in-memory State.
   b. If an update operation:
      i. The record is located in the in-memory State using the record identifier;
      ii. The updates contained in the Change are applied to the existing record, generating a new record; and
      iii. The new record is stored in the in-memory State, overwriting the old record; and
   c. If a remove operation, the record corresponding to the record identifier is removed from the in-memory State.
6. Each active Subscription contained in the current Reality 32a, 32b is analyzed to check if it contains an affected record identifier. If so, it is flagged for invalidation. (For the second time, since new data changes may have invalidated different Subscriptions).
7. Each Subscription that was flagged for invalidation has its invalidation logic run, which calculates the active component Queries for that Subscription, and re-executes those Queries, causing the relevant UI components 31a, 31b to receive state updates.
8. If the State message contained metadata regarding the percentage completion of the active replay in this Reality 32a, 32b, it is updated.
9. The processing completes, at which point control is passed to React to allow it to re-render components whose state changed during this process.

Reality Propagation

In React, UI components 31a, 31b are arranged in a tree structure. In this application, there is a single top-level root component in this tree, and the entire UI is built of components in this tree.

There is a single Reality defined to represent the majority “live” portions of the application state, representing data at the present point in time. This Reality is defined at the top level of the React component tree.

When a Replay is created, a new Reality is constructed, and associated with a component in the React component tree representing the portion of the UI in which the data will represent historical values instead of the present value. The component is also instructed to show the Replay Control UI, and the Server Agent is instructed to send a “createReality” message to the server.

When the Query Engine 33 executes Query definition functions, and those functions execute Subscriptions, the Query Engine 33 must submit the Subscription within the appropriate Reality. In order to do so, the Query Engine 33 looks up the relevant Reality using the following algorithm:
1. Does the component have a Reality defined in a property named “reality”? If so, return it. If not, go to step 2.
2. Does the component have a Reality defined in a state field name “reality”? If so, return it. If not, go to step 3.
3. Look up the parent of the component in the React component tree, and repeat this process starting at step 1 using the parent component.

Replay Control

The actual Control of a replay occurs as follows. There is a Replay Control UI component containing buttons and controls. When a button is pressed or control is activated (for example, changing the position of a slider control), for “play”, “pause”, “setReplaySpeed” and “seek” signals, the following steps are taken:
1. The active Reality is determined using the Reality propagation system.
2. Information about the desired Replay Control signal is determined from the button or control.
3. The Server Agent 34 is instructed to send a Command message to the server representing the desired Replay Control signal and any metadata about the signal.
4. Zero or more State messages are received from the server, and processed according to the steps in the “State Update Handling” section.
5. If the State message(s) included metadata about the percentage completion of the Replay, the state of the Replay Control UI is updated using that information.

For “disposeReality” signals, once the signal is sent to the server, the Replay is disposed of, along with all State, Queries and Subscriptions, and the UI component is disassociated from the Reality.

Event Processing and Storage System

In order to support the playback and analysis of past events, Dashcube needs to not only collect the data and metadata from the initial user action causing the event, but also the effects of the event. If the effects are not captured at the time the event occurs, it would become very difficult to process old events after changes to the application business logic have taken place.

Each incoming Command is processed by a “Command Handler”, which validates security and data integrity rules, as well as translating the command into a series of data update operations. For example:
1. Server receives the following command:

{

“type”:“cmd”,
“params”:{

“type”:“CreateTask”,
“data”:{

“parentId”:18,
“assigneeId”:3,
“name”:“Database backup script”,
“description”:“Create an automated

nightly backup.”
}

},
“cid”:150

}

2. Server checks for required data fields and validates them.
   Server ensures that parentId was provided, and looks up the corresponding record.
   Server ensures that the parent record is accessible to the user.
   . . . server applies further operation-specific logic to validate the Command.
3. Server generates a Change Set for the Command, containing one or more operations, each of type add, update, or remove.

[

{

“bucket”:null,
“op”:“add”,
“type”:“command”,
“id”:922233,
“data”:{...command data...}

},
{

“bucket”:18,
“op”:“add”,
“type”:“task”,
“id”:922234,
“data”:{

“parentId”:18,
“assigneeId”:3,
“name”:“Database backup script”,
“description”:“Create an automated

nightly backup.”,

“done”:false,
“creatorId”:3,
“parentType”:“cube”,
“cubeId”:18,
“id”:922234,
“type”:“task”,
“timestamp”:1422580398581,
“userstamp”:3

}

},
{

“bucket”:18,
“op”:“add”,
“type”:“activity”,
“id”:922235,
“data”:{...activity data...}

},
{

“bucket”:null,
“op”:“add”,
“type”:“notification”,
“id”:922236,
“data”:{...notification data...}

},
...additional changes...

]

It is important to make a distinction between the Command and the Change Set:
a Command captures the user action and associated data—the “cause” of the changes to be made; and
a Change Set captures the results of processing that user action—the “effects” of that action, in a format that can be applied to the data store without processing any further logic or needed access to the specific version of application logic that handled the command at this point in time.

Once generated, a Change Set follows the following sequence:
1. Stored in a on-disk database for future retrieval. Our implementation currently stores Change Sets in a MongoDB database, for example, segmented by Cube, but the specifics of this are unimportant to the system, as long as Change Sets are stored permanently and can be accessed when the Temporal Database Server starts.
2. Sent to the Temporal Database Server to be applied to the current and historical system state representation (see the Temporal Database Server section below).
3. Published to connected clients. This comprises a series of operations:
   a. The Change Set is published to each Application Server.
   b. Each Application Server evaluates the Change Set with regards to each open client connection.
   c. For a given Change Set and open client connection, the server compares each Change in the Change Set against the active Subscriptions contained in that open connection.
   d. If the Change matches an active Subscription, it adds the Change to a Queue for that open connection.
   e. Once the whole Change Set is processed for that open connection, the server sends the Changes in the Queue to the connected Client.
For example:
   a. The server has one connected client, with two active Subscriptions:
      i. Find Subscription for Tasks with paren2
      ii. Find-by-id Subscription for the record with id=2
   b. A Change Set containing a single Change representing a new Task with parentId of 2 is published.
   c. This Change matches the Subscriptions, so it is sent to the Client.
   d. A Change Set containing a single Change representing a new Task with a parentId of 3 is published.
   e. This Change does not match the Subscriptions, so it is not sent to the Client.
   f. A Change Set containing two Changes is sent, one with an update to the Task with id of 2, and one with an update to the Task with id of 3.
g. The Change to the Task with id of 2 matches the Subscriptions, but the Change to the Task with id of 3 does not, so the Change to the Task with id of 2 is sent but the Change to the Task with id of 3 is not.

Server Architecture

Overview

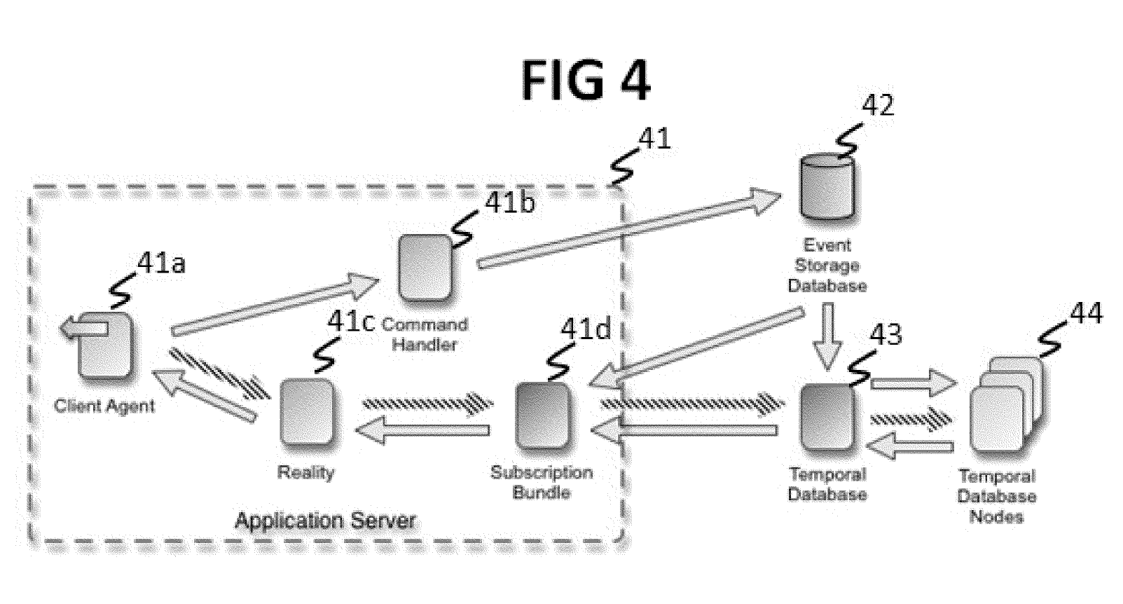

Referring to FIG. 4, the Overall Server architecture of Dashcube comprises the following elements:
Application Server 41, which is exposed to the Internet/Intranet and listens for new connections from client applications. Important components include:
   Client Agent 41a: Represents an open client connection, and acts a broker on behalf of the connected client. Maintains list of open Realities, accepts incoming Command, Subscription, and Replay Control requests.
   Command Handler 41b: Processes incoming commands, creating Change Sets (as described in the “Event Processing and Storage System” section).
   Reality 41c: Implements permissions/security checking for Subscriptions and Change Sets. Either subscribes to feed of live Change Sets (if a Live Reality), or requests past Change Sets from Temporal Database Server (if a Replay Reality).
   Subscription Bundle 41d: Tracks active Subscriptions and synchronized record state for a Client, for either the current application state or a past state. Processes new Subscription requests, and filters Change Sets against the set of active Subscriptions.
Event Storage Database 42 (described in the “Event Processing and Storage System” section).
Temporal Database Server 43 and Temporal Database Nodes 44 (described in the “Temporal Database Server” section).

Turning to FIG. 4, shown therein is a representation of an exemplary server architecture, representing the flow of commands and data within the system. In this diagram, the solid arrows represent the flow of Commands and Change Sets, and the striped arrows represent the flow of Subscribe, Query, and Replay Control requests.

Most of these components are described in depth in other sections of this document, except for Reality and Subscription Bundle.

Reality

There are two types of Realities. Live Realities, and Replay Realities. Both handle Subscription requests, applying permissions and security logic before handing them off to a Subscription Bundle. They also accept Change Sets from Subscription Bundle, again applying permissions and security logic, before returning them to the Client Agent to send in a message to the client.
Live Realities, apart from permissions and security logic, are quite simple. They:
   Pass Subscribe requests through to their Subscription Bundle; and
   Watch for Change Sets being generated as incoming Commands are processed, and feed those Change Sets to their Subscription Bundle.
Replay Realities:
   Pass Subscribe requests through to their Subscription Bundle, with one important addition: they extend the Subscribe requests with the current time of the Replay state.
   Can either be Playing, or Paused.
      i. If Playing, the Reality fetches a list of Change Sets from the Temporal Database Server every time step, following these steps:
         1. Check the desired number of Change Sets, given by the current Playback Speed in the Reality metadata.
         2. Create a list of Outgoing Change Sets.
         3. If there are no Change Sets in the Change Set Queue, request a batch of Change Sets from the Temporal Database Server, starting from the last recorded time (currently requests one hour of changes at a time), and advance the last recorded batch time.
         4. If there is at least one Change Set in the Change Set Queue:
         a. Remove the first Change Set from the Change Set Queue.
         b. Send the Change Set to the Subscription Bundle for processing.
         c. Accept the returned Change Set, if any.
         d. If a Change Set was returned from the Subscription Bundle, add it to Outgoing Change Sets.
         5. If there are enough Change Sets in the Outgoing Change Sets, send these Change Sets to the Subscription Bundle.
         6. If there are not enough Change Sets in the Outgoing Change Sets, repeat this process from Step 3 onward.
      ii. If Paused, wait for further Subscribe or Replay Control requests.
   Process incoming Replay Control signals, manipulating the state of the Replay. (Available signals are covered in “Replay Control Signals” section).
   For a seek signal:
      i. Retrieves the desired completion percentage from the signal metadata.
      ii. Converts that into a time.
      iii. Retrieves a list of Change Sets from the Temporal Database Server from the current Replay time to the converted time.
      iv. Sends each Change Set to the Subscription Bundle, collecting the results.
      v. Updates the current time in the Replay metadata.
      vi. Sends the resulting Change Sets to the Client Agent.

Subscription Bundle

Subscription Bundle is in some ways the most important piece of the Replay system. It is responsible for:
Processing Subscribe requests, wherein it:
   a. Stores metadata about the subscription.
   b. Sends a Query to the Temporal Database Server containing the criteria from the subscription, which returns zero or more records.
   c. Filters out records from the results that the client has already received.
   d. Sends remaining records in the form of a Change Set of add Changes to the Client Agent for delivery to the client in a State message, and stores metadata about the fact it has done so.
Processing Change Sets (either from newly-generated from Commands, or from streaming back changes in a Replay), wherein it:
   a. Breaks a Change Set into individual Changes, each an add, update, or remove operation.
   b. For each Change, detects whether that change is relevant to any active Subscriptions.
   c. In some cases, substitutes an add or remove Change in place of an update Change (for example, if the client is subscribed to Tasks with parentId=2, and an update Change is received changing the parentId on a Task from 2 to 3, it will translate that Change into a remove operation unless there are other active Subscriptions matching that Task).
   d. Sends resulting Changes to the Client Agent for delivery to the client in a State message, and stores metadata about the fact it has done so.

Temporal Database Server

Overview

In order to service Subscription and Replay requests, the server must be able to process queries about application state at any point in time, as well as be able to retrieve and stream data changes between multiple points in time.

To do this, an embodiment of the present invention includes a custom “Temporal Database Server” that builds up an efficient in-memory representation of all past application states as well as tracking data changes to transition from state to state. When the Temporal Database Server starts up, it requests the history of Change Sets from the permanent storage database, and uses the Change Sets to build up the application history.

While the system partitions Change Sets by Cube, but this could change, and would be different for other problem domains. Each collection of Change Sets is stored in a “Node”, which tracks the historical state of a Cube. A Node is stored inside of a “Temporal Database Worker”, which runs in a different Operating System process, to allow for distribution of requests across separate processes for performance considerations (one implementation uses Node.js technology, which does not include Threads, thus necessitating separate processes to utilize multiple CPU cores). When the Temporal Database Server starts, it creates a Worker process for each CPU core and distributes Nodes across the Worker processes.

State Representation in Nodes

The data storage in a Node comprises a series of “Snapshots” of historical states of the system, each corresponding to a single Change Set. For example:
1. Snapshot after applying Change Set 1 to empty state; stores Change Set 1 as transition.
2. Snapshot after applying Change Set 2 to previous state including Change Set 1; stores Change Set 2 as transition.
3. Snapshot after applying Change Set 3 to previous state including Change Sets 1 and 2; stores Change Set 3 as transition.

4. . . .

5. Snapshot after applying Change Set N to previous state including Change Sets 1 to N−1; stores Change Set N as transition.

Each Snapshot comprises:
Change Set applied after the previous snapshot;
Time at which the Change Set occurred;
Lookup table of active records by id; and
Data storage for indexes (to speed up queries for subsets of active records).

Our Snapshot implementation relies on persistent immutable data structures to require only a small amount of additional memory to store a new application state, thus achieving concurrent representation of thousands of application states only using the memory cost of a few application states.

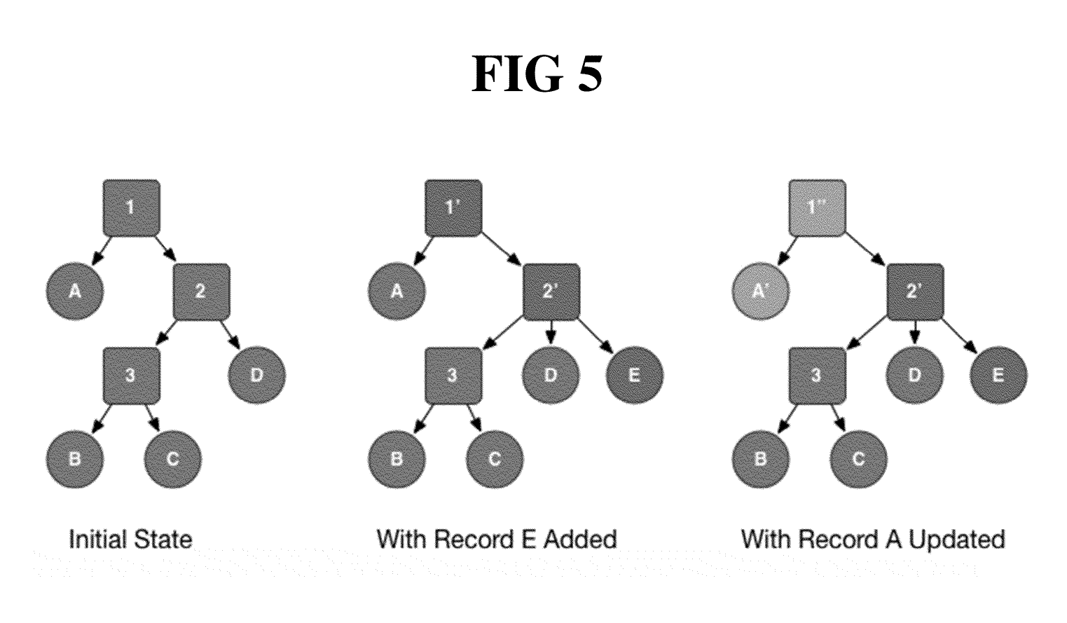

A simplified example of how a persistent data structure saves memory across changes is shown in FIG. 5. FIG. 5 is a representation of an example of how a persistent data structure changes when updates are applied, and is not directly representative of the persistent data structures used in this system.

We utilize two types of persistent data structures:
1. Hash array mapped trie—a persistent lookup table, used for:
   Lookup table of active records, keys are record ids and values are record.
   Lookup tables for each segment in each index, keys are possible index values and values are sets of record ids.
2. Sorted set—a persistent sorted list, used for:
   Lists of record ids in indexes.

The persistent data structures used are open-source implementations of standard algorithms; the present invention combines the application of these algorithms to support efficient storage and retrieval of past application states.

Algorithm for Processing Query Requests

When a Query request is received by the Temporal Database Server, the following steps occur:
1. The Query is analyzed to determine which Cubes it concerns.
2. The Worker processes storing the Node for each Cube is determined (using metadata stored in the Temporal Database Server).
3. The request is routed to one or more Worker processes using a “map-reduce” system to wait until all results are received.
4. A Worker process receives a request, and locates the appropriate Node(s) to service the request.
5. The Worker process calls a Query handling procedure on each of the Nodes.
6. The Node locates the Snapshot closest to the time requested in the Query (or, if no time was requested, it uses the present time). In this logic, the closest Snapshot is defined by the Snapshot that has the closest time with a time less than or equal to the request time. (For example, a snapshot with a time one minute prior to the requested time would be returned over a snapshot with a time one second after the requested time).
7. The Node processes the Query:
   a. If the Query was of type Find-by-id, the Node looks up the record using the provided record id and returns it.
   b. If the Query was of type Find, the Node:
      i. Analyzes the Query criteria to locate a matching Index. There will always be at least one index that matches, as the Query criteria must include a record type, and a system index exists for record type.
      ii. Retrieves the list of record identifiers for the appropriate criteria.
      iii. Iterates through the list of record identifiers, retrieving the corresponding record for each, and testing the record against the Query criteria.
      iv. Records passing the Query criteria are returned.
8. The results from the Node(s) are aggregated by each Worker process and sent to the Temporal Database Server.
9. The results from the Worker process(es) are aggregated by the Temporal Database Server and returned.

Algorithm for Processing Replay Data Requests

When a Replay Data request is received by the Temporal Database Server, the following steps occur:
1. The Replay Data request is analyzed to determine which Cubes it concerns.
2. The Worker processes storing the Node for each Cube is determined (using metadata stored in the Temporal Database Server).
3. The request is routed to one or more Worker processes using a “map-reduce” system to wait until all results are received.
4. A Worker process receives a request, and locates the appropriate Node(s) to service the request.
5. The Worker process calls a Replay Data request handling procedure on each of the Nodes.
6. The Node locates the range of Snapshots closest to the time requested in the request. The request includes both the desired start and end time. In this logic, the closest Snapshot to the start time is defined by the Snapshot that has the closest time with a time greater than or equal to the request time. (For example, a snapshot with a time one minute after to the requested time would be returned over a snapshot with a time one second prior the requested time). The logic for finding the closest snapshot to the end time is reversed.
7. The Node retrieves the Change Set contained in each Snapshot, and returns an array of Change Sets as the result.
8. The results from the Node(s) are aggregated by each Worker process and sent to the Temporal Database Server.
9. The results from the Worker process(es) are aggregated by the Temporal Database Server and returned.

How the System Turns Temporal Data into a Replay

In order to display a Replay, the user would first enter a UI state of “Replay”, which then creates a new Replay Reality (see previous section “Reality”) set in the current time for the user.

This new Replay Reality contains all of the subscriptions that the user has on the page they are currently on, (i.e., what they are looking at). These subscriptions are the pipelines that the data is traveling through from the server to the client (see previous section “Subscriptions”). They contain the queries that the client has described and sent to the server, constructed by the UI elements on the page itself. (example: a list of users on the page would have a query that populates that user list). The important addition to these queries is that they are time stamped with the current time of the Replay itself this timestamp is used later on, when the server is processing those queries (see previous section “Replay Data Requests”).

The Server will also know when a user enters Replay, by using a “createReality” Replay Control Signal, and will now be able to send them updates through the subscriptions, from any point in time, via the Temporal Database (see previous section “Temporal Database Server”). Once in Replay mode, the client can now send specific Replay Control Signals, to tell the server how the client wants to traverse through the data. The signals include play, pause, seek, etc., as described previously “Replay Control Signals”.

When the client wants to seek somewhere back in time, it sends the “seek” signal, which contains a percentage parameter. The logic on the Server will then be as follows (see “Replay Realities”):
1. Convert the percentage into a timestamp.
2. Retrieve the list of change sets (see “Event Processing and Storage System”) from the Temporal Database Server from the current timestamp to the desired timestamp.
3. Sends each one of those Change Sets through the Subscription Bundle, collecting all the results.
4. Updates the Replay Metadata to show the users the time change.
5. Send the resulting Change Sets from the Subscription Bundle to the Client Agent (see “Server Architecture”).

Once the client receives these change sets from the server, it then processes the change sets by following the State Update Handling process (see “State Update Handling”).

When the client is in Reality that is not current, they are able to “Play” changes. This is accomplished by sending the “play” Replay Control Signal, which then follows the logic for playing back change sets described previously in “Replay Realities”.

How and why a User Replays Data

The goal of Replay is to enable users, especially managers or executives, to discover the “unknown unknowns” in a business—the information which they should be asking questions about, but do not even know is a question. This information can be surfaced by replaying project state over time, which surfaces patterns in the tasks and in the communication.

To engage with the system to replay something, the user clicks a button in the UI to enter replay mode. This switches the UI into replay mode, but looking at the same information that is currently being presented (e.g., the tasks in a project, the communication on a sub-project, etc.).

The replay system shows a time control which uses a progress bar UI metaphor, which is similar to the time controls on online video sites such as YouTube. The beginning of time, shown at the left side of the time control, is the time when the parent cube was created. (A cube is the thing which contains the projects, sub-projects and all of their tasks and communication.) The end of time, shown at the right side of the time control, is the present time. Within the time control, time is spaced evenly.

The user can grab and drag a UI affordance in the time control to adjust what time is being displayed. When the dragging stops, the system updates the data to show the data as it was at that given time. This lets a user look into how they saw the tasks and communication in the project at that time in the past.

The user can click a play button to see the project unfold in a replay. Replay speed is defined in a number of events per second. An event is a task creation, a message, etc.

When events are played back, the UI is updated to show the events happening. The UI is in read-only mode during replay (after all, you cannot change the past), but it is fully interactive: every task and message can be selected and viewed, projects can be visualized in different modes (e.g., lists, Kanban boards, tree maps, etc.).

Furthermore, any dashboard visualizations that are defined based on “current” data will be updated during a replay, since a replay literally modifies what “current” is. This is why the application states are termed “Reality” states: when doing a replay, the client is constructing a reality based on how the cube data existed in the past.

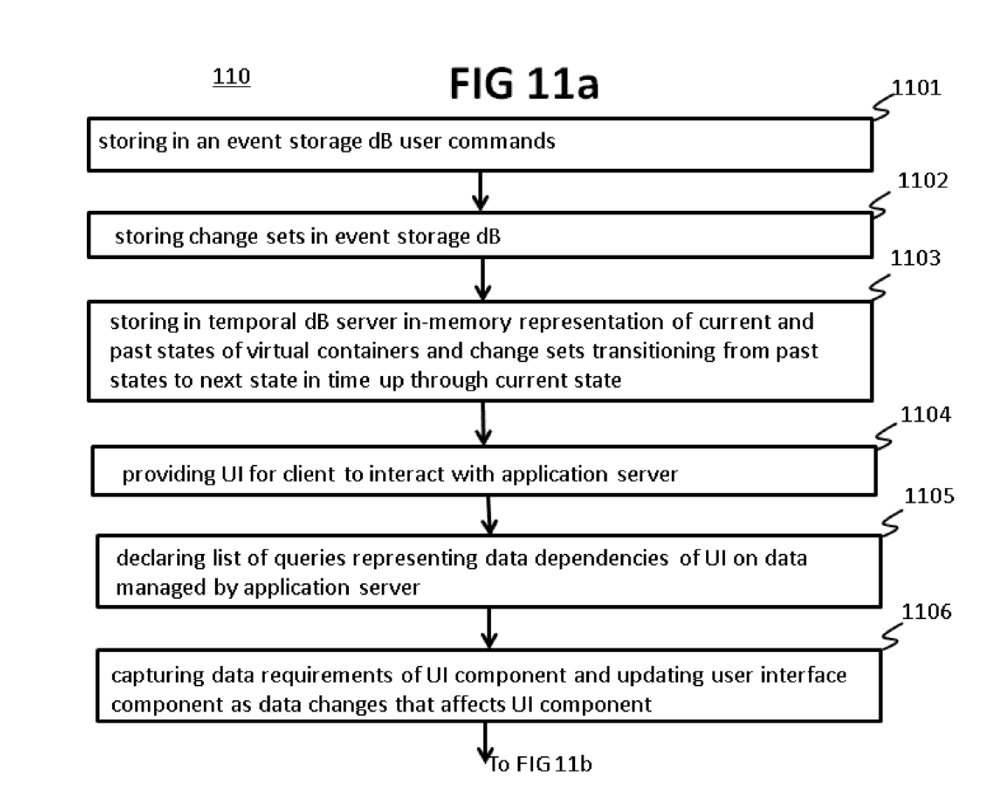

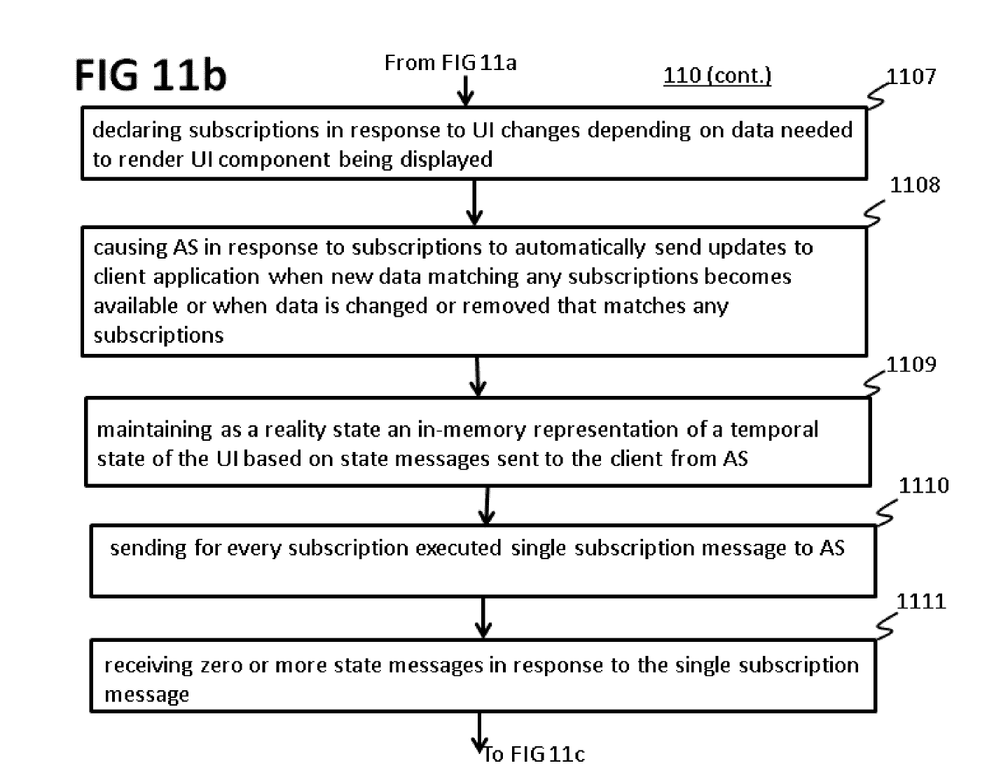

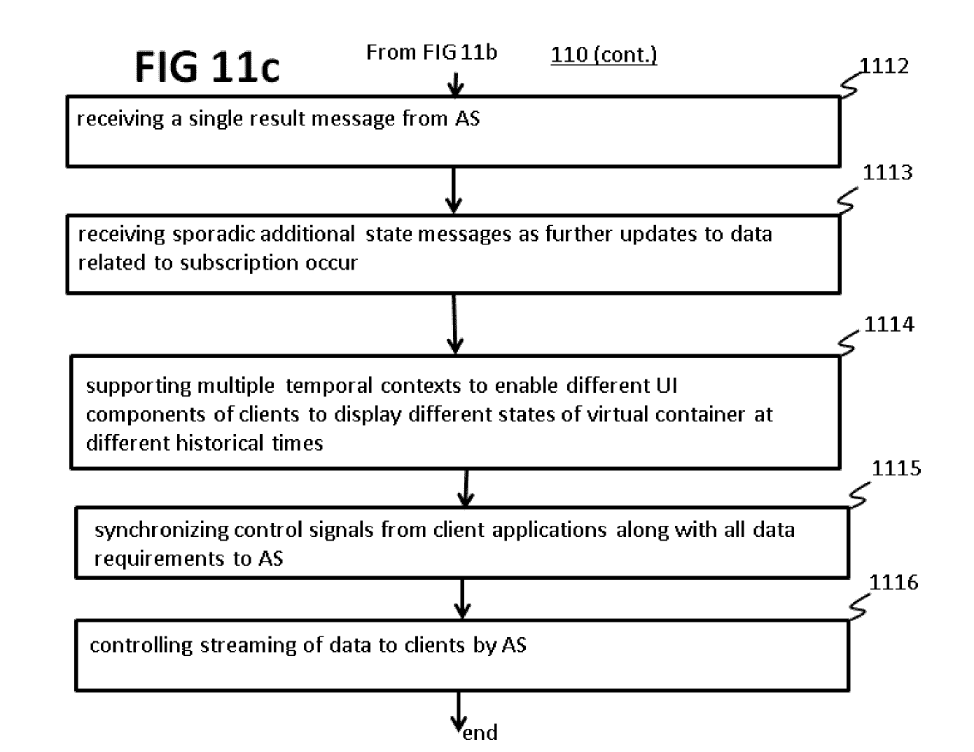

Turning to FIGS. 11a-11c, shown therein, according to yet another aspect of the present invention, is an exemplary embodiment of a method 110 for storing and replaying past states of virtual containers whose data is being managed by an application being executed on an application server coupled to several clients. This method could be applicable to any data management system that manages data for multiple users or clients. The application of the method enables users of the clients to communicate amongst each other and to collaborate within workspaces or virtual containers.

Turning to FIG. 11a, according to this method 110, step 1101 includes storing in an event storage database user commands, each of which captures user action and data associated with the user action. Any database may be employed without departing from the scope of the present invention; however, one possible database is a Mongo database.

Step 1102 includes storing change sets in the event storage database, each of which change sets includes a result of processing the user action in a format that can be stored without processing any further logic or needed access to a specific version of application logic that handled the user action at a point in time at which the user action occurred.

Step 1103 includes storing in a temporal database server an in-memory representation of a current state of each virtual containers and past states of each of the virtual containers and each change set to transition from each past state to a next state in time up through the current state.

Step 1104 includes providing a user interface for at least one client to interact with the application server. In this method, the user interface may have one or more user interface components. The temporal database server may be part of the event storage database or separate.

Step 1105 includes declaring a list of queries representing data dependencies of the user interface on data managed by the application server. This step may be performed in a client application by a user interface component, of which there may be more than one.

Step 1106 includes capturing data requirements of the user interface component and updating the user interface component as data changes that affects the user interface component. This step may be performed by a query engine within the client application.

Turning to FIG. 11b, step 1107 includes declaring subscriptions in response to user interface changes depending on data needed to render the user interface component being displayed on a screen. This step may be performed by a query engine within the client application.

Step 1108 includes causing the application server in response to the subscriptions to automatically send updates to the client application when new data matching any of the subscriptions becomes available or when data is changed or removed which matches any of the subscriptions. This step may be performed by a query engine within the client application.

Step 1109 includes maintaining as a reality state an in-memory representation of a temporal state of the user interface based on state messages sent to the client from the application server, wherein each state message includes a reality identifier, a list of changes including operation type, record identifier and data related to an operation and each state message is sent in response to one of the subscriptions. This step may be performed by a reality state within the client application.

Step 1110 includes sending, for every subscription executed, a single subscription message to the application server.

Step 1111 includes receiving zero or more state messages in response to the single subscription message.

Turning to FIG. 11c, step 1112 includes receiving a single result message from the application server.

Step 1113 includes receiving sporadic additional state messages as further updates to data related to the subscription occur. Steps 1110 through 1113 may be performed by a server agent within the client application.

Step 1114 includes supporting multiple temporal contexts to enable different user interface components of the clients to display different states of the virtual container at different historical times. This step may be performed by the application server.

Step 1115 includes synchronizing control signals from the client applications, along with all data requirements, to the application server. This step may be performed by the application server.

Step 1116 includes controlling streaming of data to the clients by the application server.

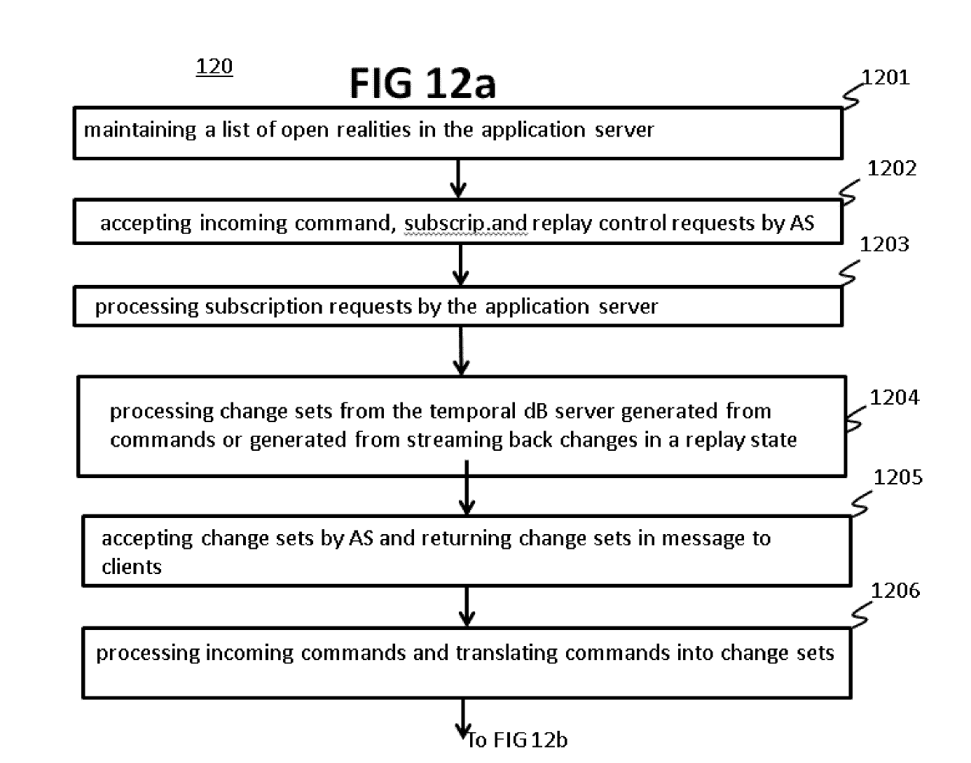

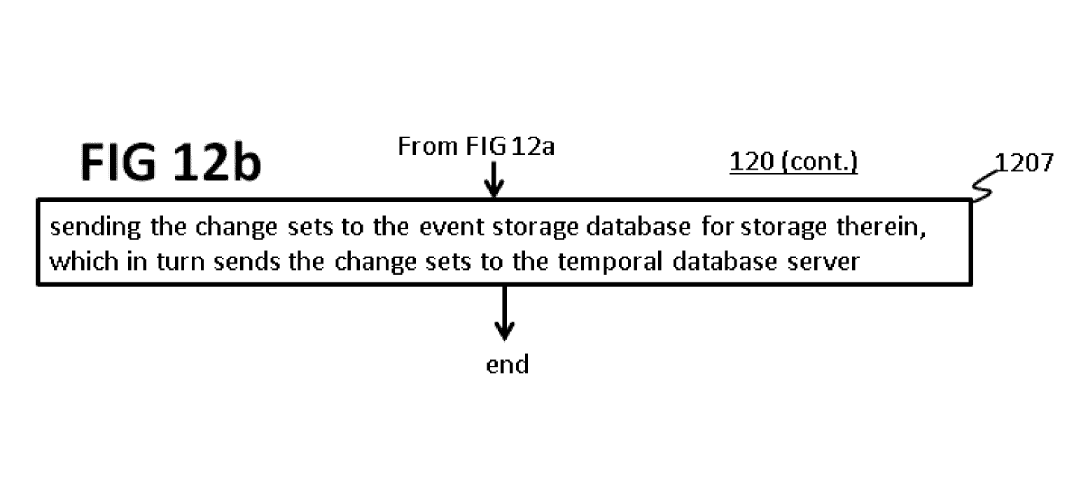

The above method 110 may also include the method 120 shown in FIGS. 12a-b.

Turning to FIG. 12a, step 1201 includes maintaining a list of open realities in the application server. This step may be performed by a client agent within the application server, in which there is a client agent for each client with an open connection.

Step 1202 includes accepting incoming command requests, subscription requests and replay control requests by the application server. This step may be performed by a subscription bundle within the application server.

Step 1203 includes processing subscription requests by the application server. This step may be performed by a subscription bundle within the application server.

Step 1204 includes processing change sets from the temporal database server generated from commands or generated from streaming back changes in a replay state. This step may be performed by a subscription bundle within the application server.

Step 1205 includes accepting change sets by the application server and returning the change sets in a message to the clients. This step may be performed by a reality state within the application server.

Step 1206 includes processing incoming commands and translating the commands into change sets. This step may be performed by a command handler within the application server.

Turning to FIG. 12b, step 1207 includes sending the change sets to the event storage database for storage therein, which in turn sends the change sets to the temporal database server. This step may be performed by a command handler within the application server.

In this method 110, the reality state may be either a live reality state representing a current state of the virtual container, or a replay reality state representing a state of the virtual container at a past time.

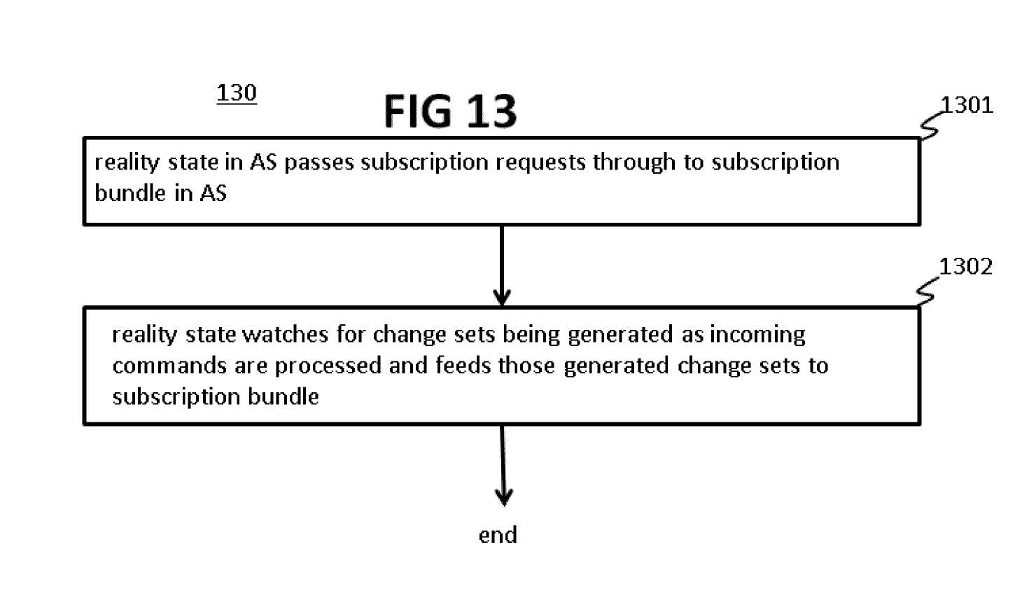

Turning to FIG. 13, for a live reality state, the reality state performs the method 130 in FIG. 13. In step 1301, the reality state in the application server passes subscription requests through to the subscription bundle in the application server.

In step 1302, the reality state watches for change sets being generated as incoming commands are processed, and feeds those generated change sets to the subscription bundle.

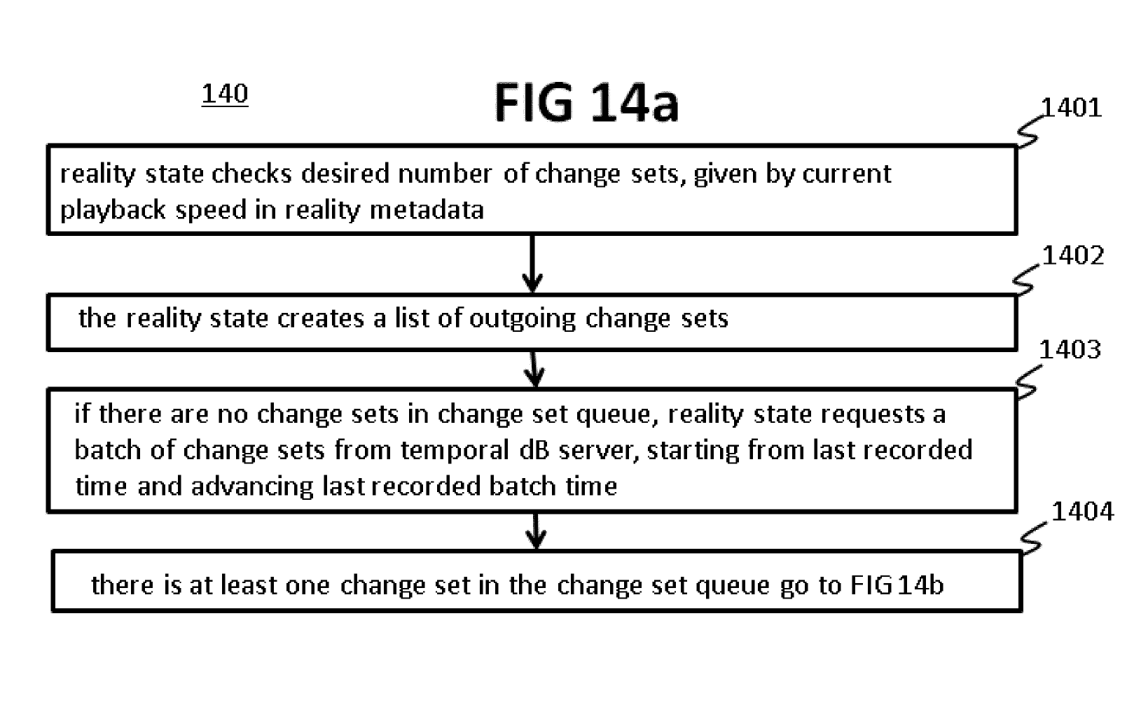

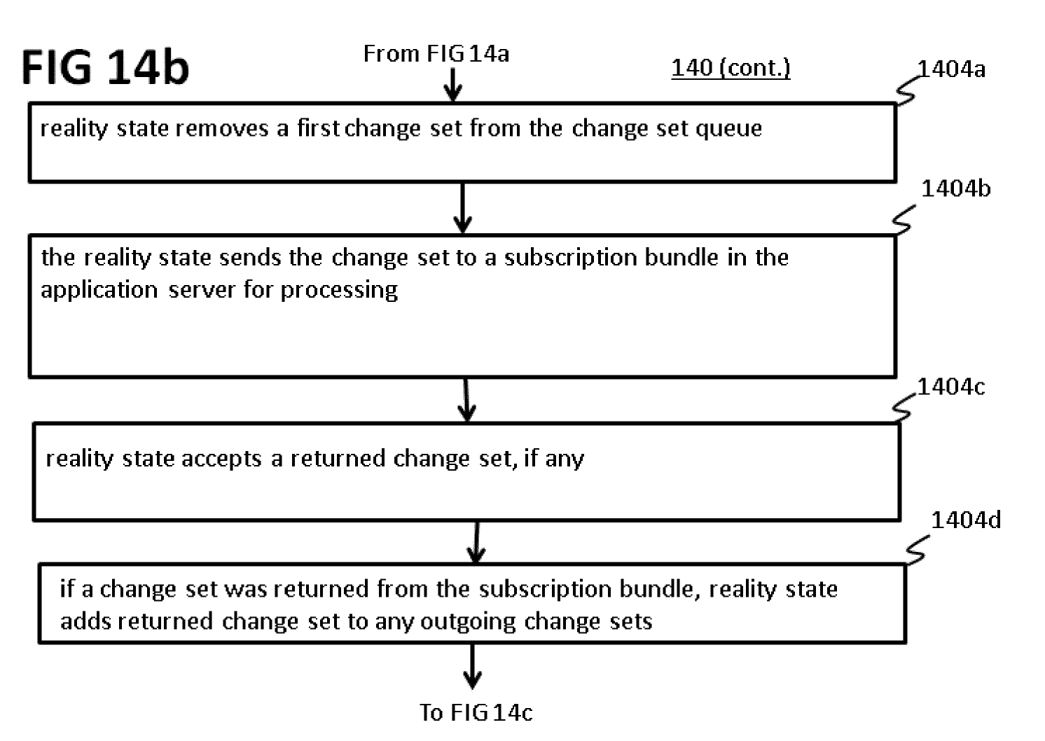

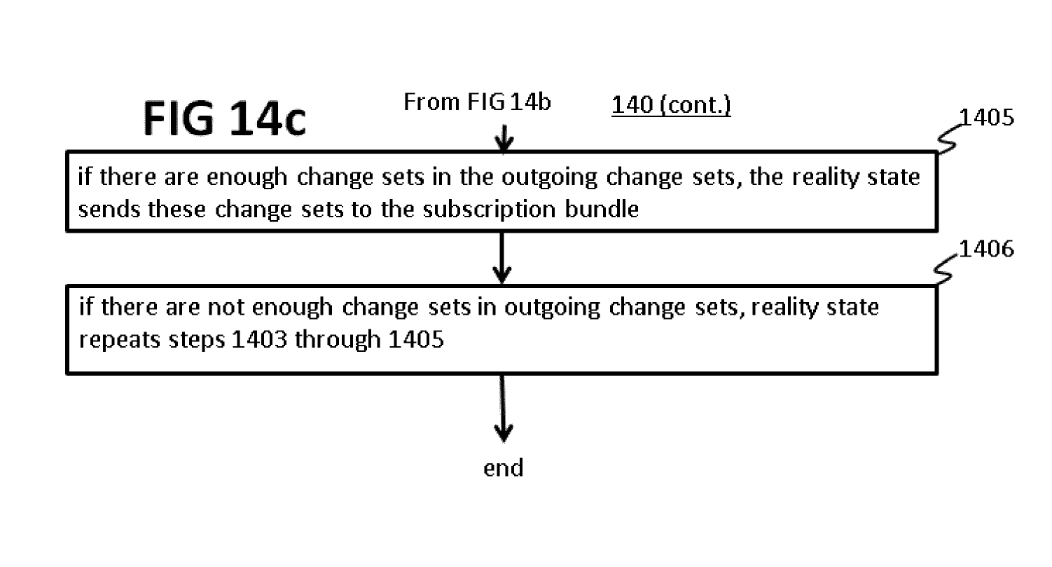

For a replay reality state, the reality state passes subscription requests through to a subscription bundle in the application server while extending the subscription requests with a current time of a replay state. In this method, the replay reality state may be playing or paused. If the replay reality state is playing, the reality state performs the method 140 in FIGS. 14a-c.

Turning to FIG. 14a, in this method 140, the reality state fetches a list of change sets from the temporal database server every time step by the following steps.

In step 1401, the reality state checks a desired number of change sets, given by a current playback speed in a reality metadata.

In step 1402, the reality state creates a list of outgoing change sets.

In step 1403, if there are no change sets in a change set queue, the reality state requests a batch of change sets from the temporal database server, starting from a last recorded time and advancing a last recorded batch time.

In step 1404, if there is at least one change set in the change set queue, the reality state performs the following steps as shown in FIG. 14b.

Turning to FIG. 14b, in step 1404a, the reality state removes a first change set from the change set queue. In step 1404b, the reality state sends the change set to a subscription bundle in the application server for processing. In step 1404c, the reality state accepts a returned change set, if any. And in step 1404d, if a change set was returned from the subscription bundle, the reality state adds the returned change set to any outgoing change sets.

Turning to FIG. 14c, in step 1405, if there are enough change sets in the outgoing change sets, the reality state sends these change sets to the subscription bundle.

In step 1406, if there are not enough change sets in the outgoing change sets, the reality state repeats steps 1403 through 1405.

In this exemplary embodiment, if the replay reality state is paused, the reality state may wait for further subscribe or replay control requests. In this exemplary embodiment, the reality state may process incoming replay control signals by manipulating a state of the replay. In this exemplary embodiment, incoming replay control signals may include: a create reality signal, which creates a reality with a replay in a paused state synchronized to a creation time of the virtual container; a dispose reality signal, which terminates a replay; a play signal, which transitions a replay from the paused state to a playing state; a pause signal, which transitions a replay from the playing state to the paused state; a set replay speed signal, which updates a playback speed in a replay metadata, which is used while playing to determine a number of change sets to return; and a seek signal, which given a desired percentage of completion of the replay, sends necessary changes to skip to a desired replay completion.

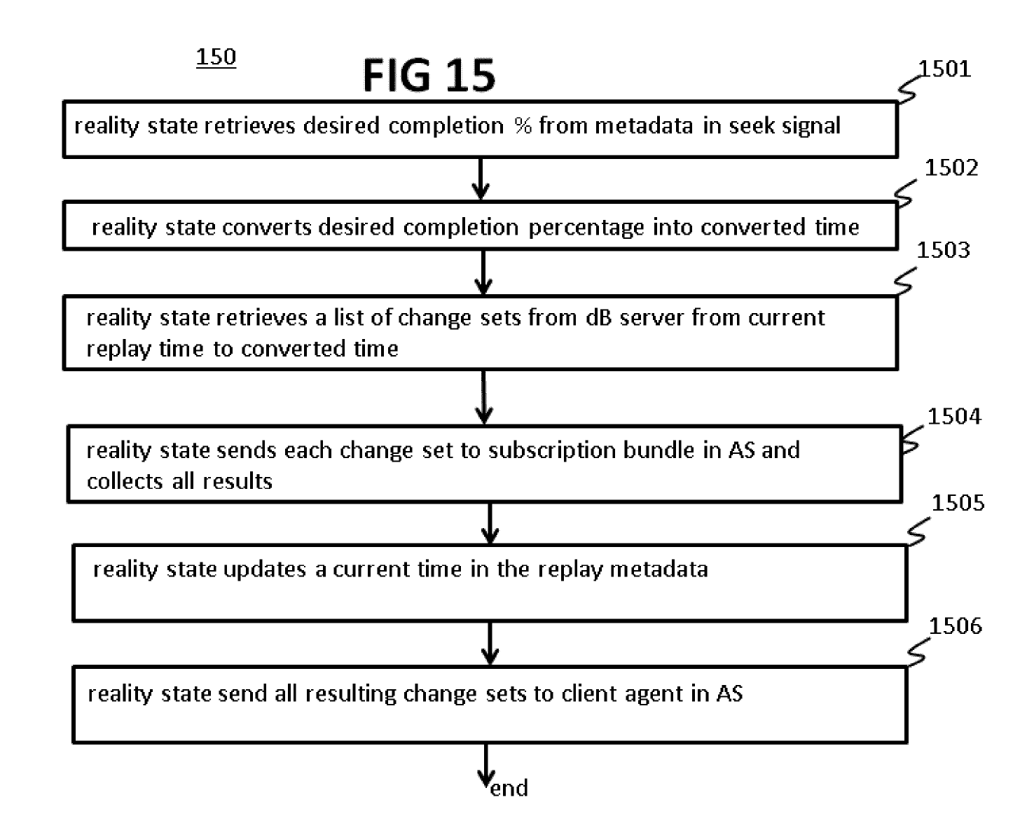

In this exemplary embodiment, upon receipt of a seek signal the reality state performs the method 10 in FIG. 15. In step 1501, the reality state retrieves a desired completion percentage from a metadata in the seek signal.

In step 1502, the reality state converts the desired completion percentage into a converted time.

In step 1503, the reality state retrieves a list of change sets from the database server from a current replay time to the converted time.

In step 1504, the reality state sends each change set to a subscription bundle in the application server and collects all results.

In step 1505, the reality state updates a current time in the replay metadata.

In step 1506, the reality state send all resulting change sets to a client agent in the application server.

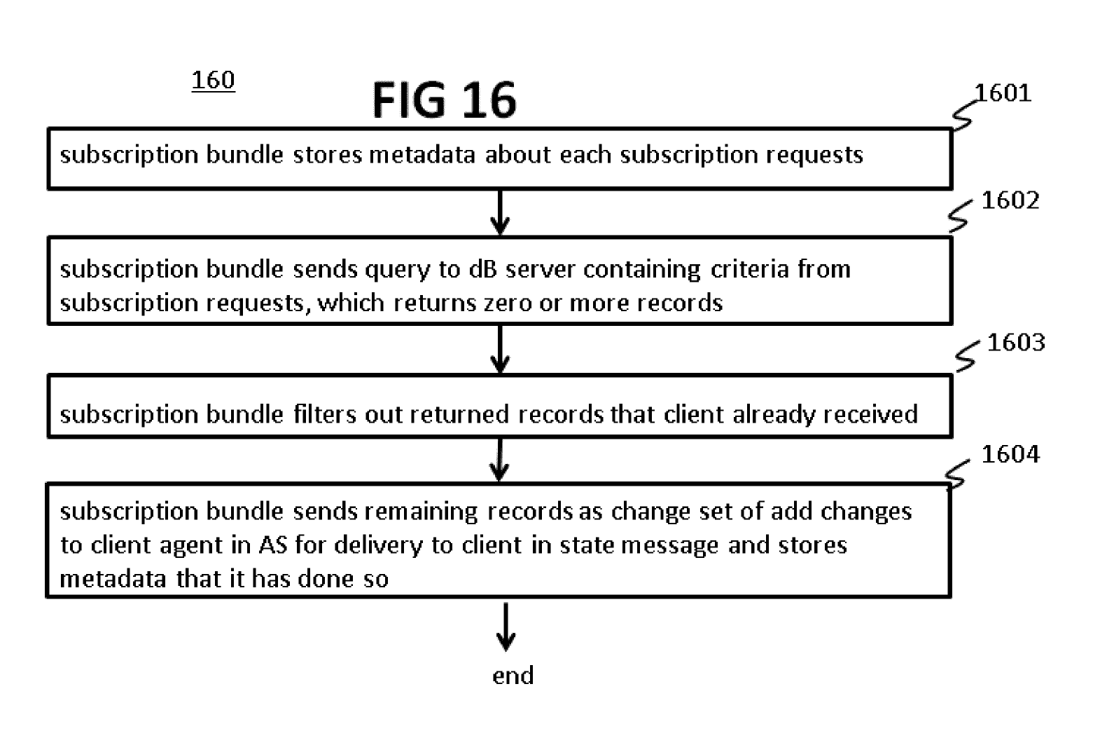

In this exemplary embodiment, the subscription bundle in the application server processes the subscription requests by performing the method 160 in FIG. 16. In step 1601, the subscription bundle stores metadata about each of the subscription requests.

In step 1602, the subscription bundle sends a query to the database server containing a criteria from each of the subscription requests, which returns zero or more records.

In step 1603, the subscription bundle filters out any returned records that each client has already received.

In step 1604, the subscription bundle sends any remaining records as a change set of add changes to each client agent in the application server for delivery to the client in a state message, and stores metadata that the subscription bundle has done so.

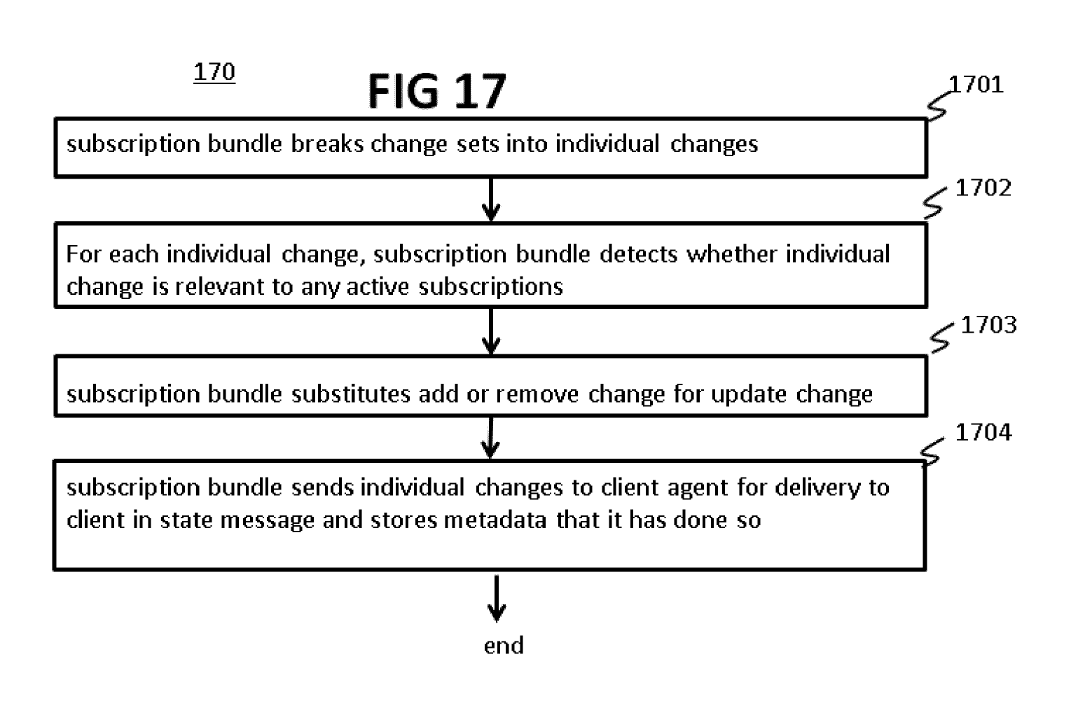

In this exemplary embodiment, the subscription bundle in the application server processes the change sets by the method 170 in FIG. 17. In step 1701, the subscription bundle breaks each of the change sets into individual changes, including an add operation, an update operation, or a remove operation.

In step 1702, for each individual change, the subscription bundle detects whether the individual change is relevant to any active subscriptions.

In step 1703, in some cases, the subscription bundle substitutes an add or remove change in place of an update change.

In step 1704, subscription bundle sends the individual changes to the client agent for delivery to the client in a state message and stores metadata that the subscription bundle has done so.

### ADDITIONAL EMBODIMENTS

In another exemplary embodiment of the present invention, one might envision “Cubes” as virtual containers that are not projects per se, but virtual workspaces with specified user access restrictions, roles and permissions, each workspace with the capacity to handle similar nested workspaces with independent or dependent roles/permissions from the parent. In this embodiment, for example, one enterprise manager's virtual container or workspace is akin to a virtual personal custom command center, presenting the communication tools, interfaces and data the manager engages with to analyze the enterprise and make decisions. Other enterprise users would each have their own workspaces, with various permissions rights for others to access, or not access, the contents of a workspace. At scale, this concept offers the enterprise a network or platform of connected workspaces, or alternatively, one big virtual workspace with multiple nested virtual workspaces. In this embodiment, the enterprise software communications platform might be considered or replaced with a virtual workspace, in which case all of the other features described above would relate to a single virtual workspace. Thus, the present invention can be scaled to handle many “Cubes” each of which can be replayed in time without departing from the scope of the present invention.

Moreover, the techniques and features herein can be applied to any data management system to permit the data to be stored in a format that is both efficient and controlled so the data can be “replayed” over time or displayed as it existed in any moment in time. Many such examples exist independent of an enterprise communications platform, including but not limited to time-stamped metrics associated with medical patients (e.g., blood count metrics, blood pressure, heart rate, body weight, etc.) or sensor-clad internet-connected equipment streaming time-stamped data (e.g., temperature, pressure, vibration, RPMs, etc.) to a database and or associated dashboards. The techniques described herein enable such a data management system to control the development of the data and how the data is stored so that such resetting a graphical data interface to a historical state and activating an associated playback capability becomes readily possible.

Other aspects of the present invention will be apparent to those of skill in the field to which this invention relates. Some include the following.

If the replay reality state is paused, the reality state waits for further subscribe or replay control requests. The reality state processes incoming replay control signals by manipulating a state of the replay. The temporal database server further comprises a plurality of worker processes, each of which worker processes runs in a different operating system process to allow for distribution of a plurality of requests across separate processes to utilize multiple CPU cores. The temporal database server stores data as a plurality of nodes, one node for each CPU core. The temporal database server starts, the temporal database server creates a plurality of worker processes, one worker process for each CPU core. The temporal database server stores data in a plurality of nodes, each node storing a single historical state of one of the virtual containers within the enterprise software communications platform, wherein each node stores a snapshot of said one virtual container at a particular point in time and a change set that transitions from a prior snapshot in time to the snapshot at the particular point in time. The temporal database server stores data in the nodes in a persistent immutable data structure. The temporal database server stores a persistent lookup table of active records using a hash array mapped trie, in which a key is a record identification and a value is a record. The temporal database server stores a persistent lookup table for each segment in each index using a hash array mapped trie, in which a key is a possible index value and a value is a set of record identifications. The temporal database server stores a persistent sorted list of record identifications in indexes. The methods herein can include; synchronizing one or more control signals from the one or more client applications, along with all data requirements, to the application server; and controlling streaming of data to said one or more clients by the application server. The methods can include maintaining a list of one or more open realities in the application server; accepting incoming command requests, subscription requests and replay control requests by the application server; processing one or more subscription requests by the application server; processing one or more change sets from the database generated from commands or generated from streaming back changes in a replay state; accepting one or more change sets by the application server and returning the one or more change sets in a message to one of the one or more clients; and processing incoming commands and translating the commands into one or more change sets; and sending the one or more change sets to the database for storage therein, which in turn sends the change sets to the database server. In the method, the reality state may be either a live reality state representing a current state of the virtual container, or a replay reality state representing a state of the virtual container at a past time. In the method, for a live reality state, the reality state: (i) passes one or more subscribe requests through to the subscription bundle; and (ii) watches for change sets being generated as incoming commands are processed, and feeds those generated change sets to the subscription bundle. In the method, in the case of a replay reality state, the reality state passes one or more subscribe requests through to the subscription bundle while extending the one or more subscribe requests with a current time of a replay state and the replay reality state may be playing or paused. In the method, if the replay reality state is playing, the reality state fetches a list of change sets from the database server every time step by: a) checking a desired number of change sets, given by a current playback speed in a reality metadata; b) creating a list of outgoing change sets; c) if there are no change sets in a change set queue, requesting a batch of change sets from the database server, starting from a last recorded time and advancing a last recorded batch time; d) if there is at least one change set in the change set queue: (i) removing a first change set from the change set queue; (ii) sending the change set to a subscription bundle in the application server for processing; (iii) accepting a returned change set, if any; and (iv) if a change set was returned from the subscription bundle, adding the returned change set to any outgoing change sets; e) if there are enough change sets in the outgoing change sets, sending these change sets to the subscription bundle; and f) if there are not enough change sets in the outgoing change sets, repeating steps c) through e). 39. In the method, if the replay reality state is paused, the reality state waits for further subscribe or replay control requests. In the method the reality state processes incoming replay control signals by manipulating a state of the replay. 41. In the method, the incoming replay control signals include: a create reality signal, which creates a reality with a replay in a paused state synchronized to a creation time of the virtual container; a dispose reality signal, which terminates a replay; a play signal, which transitions a replay from the paused state to a playing state; a pause signal, which transitions a replay from the playing state to the paused state; a set replay speed signal, which updates a playback speed in a replay metadata, which is used while playing to determine a number of change sets to return; and a seek signal, which given a desired percentage of completion of the replay, sends necessary changes to skip to a desired replay completion. In the method, upon receipt of a seek signal the reality state: retrieves a desired completion percentage from a metadata in the seek signal; converts the desired completion percentage into a converted time; retrieves a list of change sets from the database server from a current replay time to the converted time; sends each change set to a subscription bundle in the application server and collects all results; updates a current time in the replay metadata; and sends all resulting change sets to a client agent in the application server. In the method, a subscription bundle in the application server processes the one or more subscription requests by: a) storing metadata about each of the one or more subscription requests; b) sending a query to the database server containing a criteria from each of the one or more subscription requests, which returns zero or more records; c) filtering out any returned zero or more records that said each client has already received; and d) sending any remaining records as a change set of add changes to the each client agent in the application server for delivery to said each client in a state message, and storing metadata that the subscription bundle has done so. In the method, a subscription bundle in the application server processes the one or more change sets by: a) breaking each of the one or more change sets into one or more individual changes, including an add operation, an update operation, or a remove operation; b) for each individual change, detecting whether said each individual change is relevant to any active subscriptions; c) in some cases, substituting an add or remove change in place of an update change; and d) sending the one or more individual changes to the client agent for delivery to the client in a state message and storing metadata that the subscription bundle has done so.

What is claimed is:

1. An apparatus for storing and replaying one or more past states of an application comprising:
an application server to couple to one or more clients, said application server to execute the application to enable a plurality of users of the one or more clients to communicate amongst each other within a virtual container;
an event storage database to store: i) a plurality of user commands, each of which captures one user action and data associated with the one user action; and ii) a plurality of change sets, each of which includes a result of processing the one user action in a format that can be stored without processing any further logic or needed access to a specific version of application logic that handled the one user action at a point in time the one user action occurred;
a temporal database server to couple to the event storage database and to store an in-memory representation of a current state of the virtual container and a plurality of past states of the virtual container and each change set of the plurality of change sets to transition from each past state of the plurality of past states to a next state in time of the plurality of past states up through the current state;
a non-transitory computer readable media having stored thereon instructions for a processor to execute a client application to provide a user interface for at least one client of the one or more clients to interact with the application server, said client application including:
a) a user interface component to declare a list of queries representing data dependencies of the user interface on data managed by the application server;
b) a query engine to capture data requirements of the user interface component and to update the user interface component as data changes that affects the user interface component, said query engine to declare one or more subscriptions in response to user interface changes depending on data needed to render the user interface component being displayed on a screen, wherein said one or more subscriptions cause the application server to automatically send updates to the client application when new data matching any of the one or more subscriptions becomes available or when data is changed or removed which matches any of the one or more subscriptions;
c) a reality state to maintain an in-memory representation of a temporal state of the user interface based on one or more state messages sent to the client from the application server, wherein each of said one or more state messages includes a reality identifier, a list of changes including operation type, record identifier and data related to an operation and each of said one or more state messages are sent in response to one of the one or more subscriptions; and
d) a server agent to communicate with the application server, wherein each reality state communicates with the application server via the server agent, and wherein for every subscription executed, the reality state sends a single subscription message to the application server, receives zero or more state messages in response to the single subscription message, receives a single result message from the server, and receives one or more sporadic additional state messages as further updates to data related to the subscription occur;
wherein said application server supports multiple temporal contexts to enable different user interface components of the one or more clients to display different states of the virtual container at different historical times; and
wherein one or more control signals from the one or more client applications, along with all data requirements, are synchronized to the application server, which then controls streaming of data to said one or more clients.

2. The apparatus according to claim 1, wherein the application server further comprises for each client:
a) a client agent to communicate with each of the one or more clients, said client agent representing an open client connection and acting as a broker on behalf of each of one or more connected clients, said client agent maintaining a list of one or more open realities, accepting incoming command requests, subscription requests and replay control requests;
b) a subscription bundle to process one or more subscription requests and to process one or more change sets from the temporal database server either from commands generating new change sets or from change sets generated while streaming back changes in a replay state;
c) a reality state to: (i) process one or more subscription requests; (ii) apply permissions and security logic before handing off the one or more subscription requests to the subscription bundle; (iii) accept one or more change sets from the subscription bundle; and (iv) apply permissions and security logic before returning the one or more change sets to the client agent to send in a message to a client; and
d) a command handler to couple to the event storage database, to process incoming commands and to translate the commands into one or more change sets, and to send the one or more change sets to the event storage database for storage therein, which in turn sends the change sets to the temporal database server.

3. The apparatus according to claim 2, wherein the reality state may be either a live reality state representing a current state of the virtual container, or a replay reality state representing a state of the virtual container at a past time.

4. The apparatus according to claim 3, wherein for a live reality state, the reality state: (i) passes one or more subscribe requests through to the subscription bundle; and (ii) watches for change sets being generated as incoming commands are processed, and feeds those generated change sets to the subscription bundle.

5. The apparatus according to claim 3, wherein in the case of a replay reality state, the reality state passes one or more subscribe requests through to the subscription bundle while extending the one or more subscribe requests with a current time of a replay state and the replay reality state may be playing or paused.

6. The apparatus according to claim 5, wherein if the replay reality state is playing, the reality state fetches a list of change sets from the temporal database server every time step by:
a) checking a desired number of change sets, given by a current playback speed in a reality metadata;
b) creating a list of outgoing change sets;
c) if there are no change sets in a change set queue, requesting a batch of change sets from the temporal database server, starting from a last recorded time and advancing a last recorded batch time;
d) if there is at least one change set in the change set queue:
(i) removing a first change set from the change set queue;
(ii) sending the change set to the subscription bundle for processing;
(iii) accepting a returned change set, if any; and
(iv) if a change set was returned from the subscription bundle, adding the returned change set to any outgoing change sets;
e) if there are enough change sets in the outgoing change sets, sending these change sets to the subscription bundle; and
f) if there are not enough change sets in the outgoing change sets, repeating steps c) through e).

7. The apparatus according to claim 2, wherein said incoming replay control signals include:
a create reality signal, which creates a reality with a replay in a paused state synchronized to a creation time of the virtual container;
a dispose reality signal, which terminates a replay;
a play signal, which transitions a replay from the paused state to a playing state;
a pause signal, which transitions a replay from the playing state to the paused state;
a set replay speed signal, which updates a playback speed in a replay metadata, which is used while playing to determine a number of change sets to return;
and a seek signal, which given a desired percentage of completion of the replay, sends necessary changes to skip to a desired replay completion.

8. The apparatus according to claim 2, wherein upon receipt of a seek signal the reality state:
retrieves a desired completion percentage from a metadata in the seek signal;
converts the desired completion percentage into a converted time;
retrieves a list of change sets from the temporal database server from a current replay time to the converted time;
sends each change set to the subscription bundle and collects all results;
updates a current time in the replay metadata; and
sends all resulting change sets to the client agent.

9. The apparatus according to claim 2, wherein the subscription bundle processes the one or more subscription requests by:
a) storing metadata about each of the one or more subscription requests;
b) sending a query to the temporal database server containing a criteria from each of the one or more subscription requests, which returns zero or more records;
c) filtering out any returned zero or more records that said each client has already received; and
d) sending any remaining records as a change set of add changes to the each client agent for delivery to said each client in a state message, and storing metadata that the subscription bundle has done so.

10. The apparatus according to claim 2, wherein the subscription bundle processes the one or more change sets by:
a) breaking each of the one or more change sets into one or more individual changes, including an add operation, an update operation, or a remove operation;
b) for each individual change, detecting whether said each individual change is relevant to any active subscriptions;
c) in some cases, substituting an add or remove change in place of an update change; and
d) sending the one or more individual changes to the client agent for delivery to the client in a state message and storing metadata that the subscription bundle has done so.

11. An apparatus for storing and replaying past states of one or more virtual containers being managed by an enterprise software communications platform that enables a plurality of users within each virtual container to communicate with each other via voice, video and text as well as to share and track metrics, dashboards and project tasks, said apparatus comprising:
an application server to execute the enterprise software communications platform that enables a plurality of users within each virtual container to communicate with each other via voice, video and text as well as to share and track metrics, dashboards and project tasks;
said application server to couple to one or more clients;
said application server exposed to a network and to listen for new connections from new clients;
an event storage database to store: i) a plurality of user commands, each of which captures one user action and data associated with the one user action; and ii) a plurality of change sets, each of which includes a result of processing the one user action in a format that can be stored without processing any further logic or needed access to a specific version of application logic that handled the one user action at a point in time the one user action occurred;
a temporal database server to couple to the event storage database and to store an in-memory representation of a current state of each of the one or more virtual containers and a plurality of past states of each of the one or more virtual containers and each change set of the plurality of change sets to transition from each past state of the plurality of past states to a next state in time of the plurality of past states up through the current state;
said application server further comprising for each client of the one or more clients:
a) a client agent to communicate with said each client, to maintain a list of one or more open realities, and to accept one or more incoming command requests, one or more subscription requests and one or more replay control requests;
b) a subscription bundle to process the one or more subscription requests by:
i) storing metadata about each of the one or more subscription requests;
ii) sending a query to the temporal database server containing a criteria from each of the one or more subscription requests, which returns zero or more records;
iii) filtering out any returned zero or more records that said each client has already received; and
iv) sending any remaining records as a change set of add changes to the client agent for delivery to said each client in a state message, and storing metadata that the subscription bundle has done so;
said subscription bundle to process one or more change sets from the temporal database server either from newly-generated from commands, or from streaming back changes in a replay, by:
i) breaking each of the one or more change sets into one or more individual changes, including an add operation, an update operation and a remove operation;
ii) for each individual change, detecting whether said each individual change is relevant to any active subscriptions;
iii) in some cases, substituting the add operation or the remove operation in place of the update operation; and
iv) sending the one more individual changes to the client agent for delivery to said each client in a state message and storing metadata that the subscription bundle has done so;
c) a reality state to: (i) process one or more subscription requests; (ii) apply permissions and security logic before handing off the one or more subscription requests to the subscription bundle; (iii) accept one or more change sets from the subscription bundle; and (iv) apply permissions and security logic before returning the one or more change sets to the client agent to send in a message to said each client, wherein the reality state may be either a live reality state representing a current state of one of the one or more virtual containers, or a replay reality state representing a state of one of the one or more virtual containers at a past time, and in the case of a replay reality state, the replay reality state extends the one or more subscription requests with a current time of a replay state before passing the one or more subscription requests to the subscription bundle; and
d) a command handler to couple to the event storage database, to process incoming commands and translates the commands into one or more change sets, and to send the one or more change sets to the event storage database for storage therein, which in turn sends the change sets to the temporal database server;
a non-transitory computer readable media having stored thereon instructions for a processor to execute a client application to provide a user interface for at least one client of the one or more clients to interact with the application server, said client application including:
a) a user interface component to declare a list of queries representing data dependencies of the user interface on data managed by the application server;
b) a query engine to capture data requirements of the user interface component and to update the user interface component as data changes that affects the user interface component, said query engine to declare one or more subscriptions in response to user interface changes depending on data needed to render the user interface component being displayed on a screen, wherein said one or more subscriptions cause the application server to automatically send updates to the client application when new data matching any of the one or more subscriptions becomes available or when data is changed or removed which matches any of the one or more subscriptions;
c) a reality state to maintain an in-memory representation of a temporal state of the user interface based on one or more state messages sent to the client from the application server, wherein each of said one or more state messages includes a reality identifier, a list of changes including operation type, record identifier and data related to an operation and each of said one or more state messages are sent in response to one of the one or more subscriptions; and
d) a server agent to communicate with the application server, wherein each reality state communicates with the application server via the server agent, and wherein for every subscription executed, the reality state sends a single subscription message to the application server, receives zero or more state messages in response to the single subscription message, receives a single result message from the server, and receives one or more sporadic additional state messages as further updates to data related to the subscription occur;
wherein said application server supports multiple temporal contexts to enable different user interface components of the one or more clients to display different states of the one or more virtual containers at different historical times; and
wherein one or more control signals from the one or more client applications, along with all data requirements, are synchronized to the application server, which then controls streaming of data to said one or more clients.

12. The apparatus according to claim 11, wherein when said temporal database server starts up, the temporal database server requests a history of change sets from the event storage database to build up each of the one or more virtual containers.

13. The apparatus according to claim 11, wherein the each reality state represents either a current state or a past application state at a specific point in time, and streams live events, for a current state, or streams back past events, for a past state.

14. The apparatus according to claim 13, wherein for past states, a progress bar is displayed on the user interface with a time scale representing a lifetime of data being shown, where a user can skip around in time, and control playback by pausing, resuming, and changing a playback speed of events.

15. The apparatus according to claim 11, wherein when a user interface component is instantiated, the following steps occur:
a) the list of queries is generated from a user interface component definition, in which each query in the list of queries is defined to include:
i) a key name to use to store all returned data from said each query in a user interface component state table;
ii) an optional list of one or more user interface component properties on which said each query depends; and
iii) a function definition to execute logic and return data, wherein each function definition contains: (1) one or more function calls, each of which generate one or more subscriptions, for which results are returned immediately from a current reality state; and (2) optional logic to process data returned from said each function call;
b) each query in the list of queries is executed as follows:
i) said each function contained in said each function definition of said each query is executed;
ii) said one or more subscriptions are tracked during execution of said each function; and
iii) a return value of said each function is stored in a user interface component state using said key name provided in said each query definition;
c) each subscription of said one or more subscriptions generated in said each query execution is subscribed to, such that said each query will be re-executed whenever said each subscription becomes invalidated;
d) a property change listener is generated for any property changes to the user interface component, which property change listener re-executes said each query anytime any of the user interface component properties provided in said each query definition changes; and
e) a removal listener is generated to be notified of a removal of the user interface component, in which case, said removal listener removes all of the subscriptions and query metadata as well related to the user interface component.

16. The apparatus according to claim 11, wherein the temporal database server stores data in a plurality of nodes, wherein each node stores a snapshot of said one virtual container at a particular point in time and a change set that transitions from a prior snapshot in time to the snapshot at the particular point in time.

17. The apparatus according to claim 16, wherein each snapshot comprises a change set applied after a previous snapshot, a time at which the change set occurred, a lookup table of active records by identification, and data storage for indexes to speed up queries for subsets of active records.

18. The apparatus according to claim 11, wherein when the temporal database server receives a query, the following steps occur:
determining by the temporal database server which particular virtual container of said one or more of virtual containers the query concerns;
determining which one or more worker processes store a node for said particular virtual container determined using metadata stored in the temporal database server;
routing by the temporal database server the query to the one or more determined worker process using a map-reduce system to wait until all results are received;
receiving the query by the one or more worker processes and locating by the worker process an appropriate node to service the query;
calling by the one or more worker processes a query handling procedure on the appropriate node;
locating by the appropriate node a snapshot closest to a time requested in the query, if no time was requested, using a current time, wherein a closest snapshot is defined by a snapshot that has a closest time with a time less than or equal to a request time;
processing by the appropriate node the query:
a) if the query was of type find-by-id, the appropriate node looks up a record using a provided record id and returns it;
b) if the query was of type find, the appropriate node:
i) analyzes a query criteria to locate a matching index;
ii) retrieves a list of record identifiers for the query criteria;
iii) iterates through the list of record identifiers, retrieving a corresponding record for each, and testing the corresponding record against the query criteria;
iv) returns one or more records passing the query criteria;
aggregating results from one or more nodes by each of the one or more worker processes and sending the node aggregated results to the temporal database server; and
aggregating node results from the one or more worker processes by the temporal database server and returning the worker process aggregated results.

19. The apparatus according to claim 11, wherein when a replay data request is received by the temporal database server, the following steps occur:
analyzing the replay data request to determine which particular virtual container of the one or more virtual containers the replay request concerns;
determining one or more worker processes storing a node for said particular virtual container determined using metadata stored in the temporal database server;
routing the replay data request to the one or more worker processes using a map-reduce system to wait until all results are received;
receiving by each of the one or more worker processes the replay data request and locating one or more appropriate nodes to service the replay data request;
calling by the each of the one or more worker processes a replay data request handling procedure on each of the one or more appropriate nodes;
locating by each of the one or more appropriate nodes a range of snapshots closest to a time requested in the replay data request, wherein the replay data request includes both a desired start and an end time, and a closest snapshot to the desired start time is defined by a snapshot that has a closest time with a time greater than or equal to a request time and a logic for finding a closest snapshot to the end time is reversed;
retrieving by each of the one or more appropriate nodes a change set contained in each snapshot, and returning an array of change sets as a result;
first aggregating one or more returned results from the one or more appropriate nodes by each of the one or more worker processes and sending an aggregated result to the temporal database server; and
second aggregating by the temporal database server a one or more aggregated results from the one or more worker processes and returning a result of the second aggregating as a result to the replay data request.

20. The apparatus according to claim 11, wherein when the server agent receives a state message:
a) the reality is located using the reality identifier contained in the state message;
b) a change set in the state message is retrieved and sent to the reality for processing;
c) a list of affected record identifiers is extracted from the change set in the state message;
d) each active subscription contained in a current reality is analyzed to check if said each active subscription contains an affected record identifier, and if so an affected active subscription is flagged for invalidation;
e) each change in the retrieved change set is applied;
i) if an add operation, a new record is added to the in-memory state;
ii) if an update operation:
1) an existing record is located in the in-memory state using a record identifier;
2) one or more updates contained in the retrieved change are applied to the existing record thereby generating a new record; and
3) the new record is stored in the in-memory state, overwriting the existing record; and
iii) if a remove operation, a record corresponding to the record identifier is removed from the in-memory state;
f) each active subscription contained in a current reality is analyzed to check if said active subscription contains an affected record identifier, and if so, said each active subscription is flagged for invalidation;
g) each flagged active subscription that was flagged for invalidation has its invalidation logic run, which calculates the active component queries for that subscription, and re-executes those queries, causing the relevant user interface component to receive state updates.
h) if a state message contained metadata regarding a percentage completion of an active replay in the reality, the percentage completion is updated; and
i) the user interface component is re-rendered if its state changed during this process.

21. The apparatus according to claim 11, wherein when the command handler generates a change set is generated:
a) the change set is stored in the event storage database;
b) the change set is sent to the temporal database server to be applied to a current state representation and an historical system state representation; and
c) the change set is published to the one or more clients:
i) the change set is published to the application server, which evaluates the change set with regards to each open client connection; and
ii) for a given change set and an open client connection, the application server compares each change in the change set against the active subscriptions contained in the open client connection, and if the change matches an active subscription, the application server adds the change to a queue for said open client connection.

22. An apparatus to enable an application executing on an application server to store and replay one or more past states of one or more virtual containers the data for which is managed by the application server comprising:
an event storage database to store: i) a plurality of user commands, each of which captures one user action and data associated with the one user action; and ii) a plurality of change sets, each of which includes a result of processing the one user action in a format that can be stored without processing any further logic or needed access to a specific version of application logic that handled the one user action at a point in time the one user action occurred;
a temporal database server to couple to the event storage database and to store an in-memory representation of a current state of each of the one or more virtual containers and a plurality of past states of each of the one or more virtual containers and each change set of the plurality of change sets to transition from each past state of the plurality of past states to a next state in time of the plurality of past states up through the current state;
a non-transitory computer readable media having stored thereon instructions for a processor to execute a client application to provide a user interface for a client to interact with the application server, said client application including:
a) a user interface component to declare a list of queries representing data dependencies of the user interface on data managed by the application server;
b) a query engine to capture data requirements of the user interface component and to update the user interface component as data changes that affects the user interface component, said query engine to declare one or more subscriptions in response to user interface changes depending on data needed to render the user interface component being displayed on a screen, wherein said one or more subscriptions cause the application server to automatically send updates to the client application when new data matching any of the one or more subscriptions becomes available or when data is changed or removed which matches any of the one or more subscriptions;
c) a reality state to maintain an in-memory representation of a temporal state of the user interface based on one or more state messages sent to the client from the application server, wherein each of said one or more state messages includes a reality identifier, a list of changes including operation type, record identifier and data related to an operation and each of said one or more state messages are sent in response to one of the one or more subscriptions; and
d) a server agent to communicate with the application server, wherein each reality state communicates with the application server via the server agent, and wherein for every subscription executed, the reality state sends a single subscription message to the application server, receives zero or more state messages in response to the single subscription message, receives a single result message from the server, and receives one or more sporadic additional state messages as further updates to data related to the subscription occur;
wherein said temporal database server stores and creates multiple temporal contexts to enable different user interface components to display different states of the virtual containers at different historical times.

23. A method for storing and replaying one or more past states of one or more virtual containers whose data is being managed by an application being executed on an application server coupled to one or more clients, and the application enables a plurality of users of the one or more clients to communicate amongst each other within one of the one or more virtual containers, said method comprising:
storing in a database a plurality of user commands, each of which captures one user action and data associated with the one user action;
storing in the database a plurality of change sets, each of which includes a result of processing the one user action in a format that can be stored without processing any further logic or needed access to a specific version of application logic that handled the one user action at a point in time the one user action occurred;
storing in a database server an in-memory representation of a current state of each of the one or more virtual containers and a plurality of past states of each of the one or more virtual containers and each change set of the plurality of change sets to transition from each past state of the plurality of past states to a next state in time of the plurality of past states up through the current state;
providing a user interface for at least one client of the one or more clients to interact with the application server, said user interface having one or more user interface components;
declaring a list of queries representing data dependencies of the user interface on data managed by the application server;
capturing data requirements of the user interface component and updating the user interface component as data changes that affects the user interface component;
declaring one or more subscriptions in response to user interface changes depending on data needed to render the user interface component being displayed on a screen;
causing the application server in response to the one or more subscriptions to automatically send updates to the client application when new data matching any of the one or more subscriptions becomes available or when data is changed or removed which matches any of the one or more subscriptions;
maintaining as a reality state an in-memory representation of a temporal state of the user interface based on one or more state messages sent to the client from the application server, wherein each of said one or more state messages includes a reality identifier, a list of changes including operation type, record identifier and data related to an operation and each of said one or more state messages are sent in response to one of the one or more subscriptions; and
sending, for every subscription executed, a single subscription message to the application server;
receiving zero or more state messages in response to the single subscription message;
receiving a single result message from the application server;
receiving one or more sporadic additional state messages as further updates to data related to the subscription occur; and
supporting multiple temporal contexts to enable different user interface components of the one or more clients to display different states of the virtual container at different historical times.
